(19) United States
(12) Patent Application Publication
(10) Pub. No.: US 2014/0095122 A1
(43) Pub. Date: Apr. 3, 2014

(54) METHOD, APPARATUS AND SYSTEM FOR CUSTOMIZING A BUILDING VIA A VIRTUAL ENVIRONMENT

(71) Applicant: BLUHOMES, INC., Waltham, MA (US)

(72) Inventors: Joshua Appleman, Cambridge, MA (US); Dennis Michaud, Somerville, MA (US); Francois Dujardin, Tours (FR); Shan He, Somerville, MA (US)

(73) Assignee: BLU HOMES, INC., Waltham, MA (US)

(21) Appl. No.: 14/119,218

(22) PCT Filed: May 23, 2012
(86) PCT No.: PCT/US2012/039222

§ 371 Date: Nov. 21, 2013

Related U.S. Application Data
(60) Provisional application No. 61/519,543, filed on May 23, 2011.
(60) Provisional application No. 61/519,600, filed on May 24, 2011.
(60) Provisional application No. 61/626,068, filed on Sep. 20, 2011.

(51) Int. Cl. G06F 17/50; G06T 19/20

(52) U.S. Cl. CPC G06F 17/5004; G06T 19/20
USPC 703/1

(57) ABSTRACT

A configurator platform and a corresponding configurator environment, according to an embodiment of the invention enable a user to navigate a displayed virtual representation of a building configuration. The user is also enabled to customize the building configuration. The customization is based on a set of physical product specifications from which the user may make selections. A building configuration may be stored as a plurality of tags indicative of physical product specifications included in the building configuration. The building configuration may be sent to an engineering system where it is translated into an engineering model of the building. The configuration platform may further provide interaction with a geographic information system to provide environmental, geologic, and regulatory information as well as other location-based data associated with the geographic location of the building.

### RELATED APPLICATION(S)

This application claims the benefit of U.S. Provisional Application No. 61/519,543, filed on May 23, 2011, entitled “Method and Apparatus for Enabling a Viewer to Customize an Environment,” U.S. Provisional Application No. 61/519,600, filed on May 24, 2011, entitled “Method and Apparatus for Enabling a Viewer to Customize an Environment,” and U.S. Provisional Application No. 61/626,068, filed on Sep. 20, 2011, entitled “Method and Apparatus for Enabling a Viewer to Customize an Environment.”

The entire teachings of the above applications are incorporated herein by reference.

### BACKGROUND OF THE INVENTION

Advances in computer electronics and computer graphics technology had led to a variety of applications using two- and three-dimensional graphics such as computer games and configuration applications used, for example, in the manufacturing industry.

Architects, for example, use computer-aided design (CAD) to design building structures. CAD software tools enable architects to visualize structures and verify structural integrity of the structures under various conditions, such as wind loads. CAD has also been used for floor plans to allow home buyers to determine sizes of furniture or appliances that a room will accommodate. Such CAD tools are useful to architects and home buyers.

The revolution in electronics and software over the last few decades, however, has not produced the desired significant effect on housing industry. Specifically, in the context of user experience, there have not been significant improvements in terms of making use of advances in the digital world.

### SUMMARY OF THE INVENTION

In accordance with one aspect, a method of enabling a viewer to configure a building comprises presenting to the viewer a virtual three dimensional (3D) representation of a configuration of the building; providing access to a plurality of specifications of physical products associated with the building; enabling the viewer to select specifications of the physical products; modifying the configuration of the building based on the selected specifications of the physical products; and enabling the viewer to navigate inside the virtual 3D representation of the configuration of the building according to a viewer controlled navigation. The virtual 3D representation is structured based on specifications of physical products, within multiple categories, and relationships among the physical products in the configuration of the building.

According to another aspect, a method of enabling a viewer to configure a building comprises presenting to the viewer a virtual representation of a configuration of the building; providing a plurality of physical product specifications of products associated with the building; enabling the viewer to select physical product specifications; modifying the configuration of the building based on the selected physical product specifications; and providing interaction with a geographic information system, maintaining geographic information related to a location of the building. The virtual representation is structured based on physical product specifications of products, within multiple categories, and relationships among the products in the configuration of the building. The geographic information includes, but is not limited to, geologic, environmental, and/or regulatory information.

According yet to another aspect, a method of enabling a viewer to configure a building comprises presenting to the viewer a virtual representation of a configuration of the building; providing a plurality of physical product specifications of products associated with the building, the virtual representation is structured based on physical product specifications of products, within multiple categories, and relationships among the products in the configuration of the building; enabling the viewer to select physical product specifications, modifying the configuration of the building based on the selected physical product specifications, and enabling the viewer to save the configuration of the building as a plurality of tags indicative of the physical product specifications based on which the virtual representation of the building configuration is structured.

According to another aspect, a method comprises simplifying geometrical data of an engineering model of a building to produce a simplified three-dimensional (3D) representation of the building; associating the simplified 3D representation of the building and a subset of a set of 3D representations of physical product specifications to a 3D building configuration; and adding navigation features, within a 3D authoring platform, to the simplified 3D representation of the building to enable 3D navigation of the 3D building configuration.

According to another aspect, a method comprises parsing a plurality of tags indicative of physical product specifications associated with a configuration of a building and mapping the configuration and the physical product specifications to an engineering model of the building.

Each of the methods, according to the different aspects above, may be implemented as a computer code instructions stored in a computer-readable medium. The computer code instructions, when executed by a processor, cause an apparatus to perform the corresponding method. The computer code instructions may be in the form of an application software operable on a client device, network server, cloud of servers, or combination thereof. The application software may be a web-based application operable on a browser, application software with Weblet interface, stand-alone application software, or the like.

In enabling the viewer to configure the building, the viewer is enabled to navigate, in a virtual walk, inside, outside, and between the inside and the outside of the virtual 3D representation of the configuration of the building. The viewer is further enabled to remove a portion of the 3D representation of the configuration of the building, e.g., a wall, ceiling, upper floor, furniture, or the like, and visualize the 3D representation without the removed portion. The viewer is further enabled to personalize one or more visualization settings, e.g., viewpoint height, depth of field, field view, lighting conditions, or the like, and the virtual 3D representation is then displayed according to the personalized one or more visualization settings. When navigating the 3D representation of the configuration of the building, the viewer is enabled to rotate a current viewpoint or switch from a current viewpoint to a preconfigured viewpoint associated, for example, with a space area or a last modified product category in the building configuration. The viewer is further enabled to map the virtual 3D representation of the building on a representation of the topography of a location of the building

A virtual two dimensional (2D) representation of the building may be provided to the viewer, instead of or in combination with, the virtual 3D representation. The viewer is also enabled to switch between the virtual 3D representation and the virtual 2D representation. Switching between the virtual 2D and 3D representation may also be initiated automatically, for example, by the application software or an electronic device on which the application software is operable, based on software or hardware capabilities of the electronic device or if a frame rate, associated with presenting the virtual 3D representation, indicates a slow presentation to the viewer. When presenting to the viewer a virtual 3D representation of the configuration of the building, a 2D image of a current view of the virtual 3D representation may be simultaneously presented to the viewer.

The specifications of the physical products, herein, are digital descriptions of the corresponding physical products enabling the viewer to make cognizant selections. A specification may include a variety of information related to the corresponding physical product including such as 2D or 3D representation(s), price information, size information, quality information, brand information, or the like. For a given category of physical products, e.g. building model, landscaping, or components of the building such as appliances, flooring, lighting, cabinets, and fixtures, or the like, one or more specifications or more specifications are accessible by the viewer. Information in the specifications of the physical products may be arranged as metadata associated with the physical products. Specifications of physical products, available for selection by a viewer, may be added, removed, or updated. Adding, removing, or updating specifications of physical products may be based on, for example, marketing decision(s), availability of corresponding physical products, viewer or building location, or any other criteria.

By enabling the viewer to select from available specifications of the physical products, the viewer is enabled to customize the building configuration and visualize the customized building configuration in real time. A cost estimate of a current building configuration is presented to the viewer. As the viewer customizes the building configuration, the presented cost estimate is updated in real-time. Difference amounts in the presented cost estimate, associated with selection of one or more specifications, may also be presented to viewer. Some of the specifications of physical products available for selection may be provided to the viewer as one or more groups of product categories and the viewer is enabled to select from the one or more groups of product categories. Such groups are referred to herein as packages or palettes. The viewer is enabled to customize palettes by, for example, modifying one physical product specifications associated with the palette. However, packages are not modifiable.

A configuration of the building, e.g., a viewer customized configuration, may be represented by, or saved as, a plurality of tags. The plurality of tags is indicative of specifications of the physical products associated with the configuration of the building, an identification of the configuration of the building, a location of the building, version information associated with the specifications of the physical products, or any other information relevant to the configuration of the building. The plurality tags may be arranged in a uniform resource locator (URL) so that a first part of the URL is indicative of a web page address and a second part of the URL being indicative of the plurality of tags. Tags used in the plurality of tags may be text strings or simple identifications identifying corresponding physical products or specifications of physical products.

Collaborative customization of the configuration is provided by enabling collaborative modification of the configuration of the building by a plurality of viewers on a plurality of client devices. The collaborative modification of the configuration of the building may be simultaneous or otherwise at different time instances. For example, if the application software is operable on a server or a cloud of servers, collaborative modification of the configuration by the plurality of viewers may be simultaneous where modification made by a user is displayed to other users. In another example, a first viewer or user sends a customized configuration of the building, e.g., in the form of a plurality of tags, to one or more other viewers. A virtual representation of the first viewer customized configuration of the building is presented to at least one of the one or more other viewers based on the received plurality of tags. The at least one of the one or more other viewers are enabled to modify the first viewer customized configuration of the building through selection of one or more alternative specifications of the physical products. In collaborative configuration, each of the plurality of viewers may be enabled to individually personalize one or more visualization settings.

According to one or more other aspects, a modified configuration of the building may sent, upon completion of configuring the building by the viewer/user, to a design, engineering, and/or construction system where the configuration is translated into an engineering model. A list of tasks for performing by the viewer, related to the building construction, renovation, or remodeling process, may be presented to the viewer. Upon completion of the building construction, renovation, or remodeling process, the viewer is enabled to remotely control features of the building and energy monitoring. After the building is built, the viewer may be enabled to modify the configuration of the building, for example, as part of a later remodeling or renovation process.

Statistical data related to viewer selections of specifications of physical products is collected. The collected statistical data is used to update specifications of the physical products or to set default selections for later use by other users/viewers for example. The collected statistical data may be classified or used based one or more of viewer's location, viewer's profile, and other implicit and explicit characteristics during and/or after configuration. Known behavior of viewers or users from electronically collected personal data, e.g., on-line-shopping behavior, may also be used to set default or suggested configurations or update specifications of the building.

When enabling the user or viewer to save, or reduce, the configuration of the building as a plurality of tags, the plurality of tags may be included a document. Alternatively, the plurality of tags may be embedded in a Uniform resource Locator (URL) including a web address and the plurality of tags. The tags may be text strings or identifications indicative of names of physical products. The tags may also be indicative of other information such a location of the building.

Geographic information provided by the geographic information system is information associated with a given location and relevant to a building construction process at the particular location. The geographic information for a particular location includes geologic information, seismic information, weather related information such as snow loads, wind loads, and/or the like, regulatory information, topographic information, information related to soil type and moisture content, and/or other relevant information associated with the particular information. The GIS collected data may be used in different ways including modifying the list of available base models or even modifying the design of existing base models associated with, for example, a metropolitan area, a state, a country, and/or a county.

According to one aspect, geometrical data is simplified by reducing the geometrical resolution and removing geometrical information that would not be visible in a virtual 3D representation of a building for configuration purposes. Such non-visible geometrical information includes structural geometry, geometry related to plumbing components, electrical installation components, wall studs, or the like.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A illustrates an example embodiment of a configuration platform.

FIG. 1B illustrates another example embodiment of the configuration platform.

FIG. 2 is a flow chart of an example process associated with a configurator application of the configuration platform.

FIG. 3A illustrates an example user interface for enabling base model(s) to be visualized and customized.

FIG. 3B illustrates another example user interface for enabling base model(s) to be visualized and customized.

FIG. 4A illustrates an example user interface enabling visualization and customization of building and/or floor plan(s).

FIG. 4B illustrates an example user interface presented to a user once a floor plan is selected, to be included in the building configuration, and/or for visualization purposes.

FIGS. 5A-5F illustrate different example embodiments of enabling the user to navigate and visualize a virtual representation of a building configuration.

FIGS. 6A-6I illustrate different example embodiments of enabling customization or modification of a building configuration based on a displayed corresponding virtual representation.

FIGS. 7A to 7C illustrate navigation of a hierarchical configuration tree.

FIG. 8 is an eXtensible Markup Language (XML) document illustrating an example building configuration recipe.

FIG. 9A is a block diagram of a configuration platform according to an example embodiment of the present invention.

FIG. 9B is a flow chart of a process for simplifying a 3D engineering model into a configurator model.

FIG. 9C illustrates different example documents used with regard to displaying a representation of the building configuration.

FIGS. 10A and 10B illustrate an example user interface enabling access to a geographic information system (GIS).

FIG. 11A is an example user interface that enables mapping of a virtual representation of the building configuration onto topography of a specified location.

FIGS. 11B and 11C illustrate an example embodiment of a method for enabling planning of site work and estimating corresponding cost.

FIG. 12 illustrates services provided to a home buyer customer through the configurator platform at different stages.

### DETAILED DESCRIPTION OF THE INVENTION

A description of example embodiments of the invention follows.

Customers interested in building, buying, renovating, remodeling, and/or decorating a building, for example, may not get an accurate visualization of how the building would look before processes are complete. Once a process is completed, customers find making changes to be impractical and/or very expensive. A building as described herein includes an apartment, townhouse, house, store building, company or business building, and/or the like. Customers may have to rely on two dimensional (2D) images, architect's drawings or small three-dimensional (3D) models in order to get some visual perception of how a building to be built, renovated, remodeled and/or decorated would look at completion. Home builders sometimes build a model of a unit, e.g., a home or an apartment, to be shown to potential customers while units for sale are being built. Such an approach may not always be practical, especially when just a single home is to be built, and does not provide flexibility in visualization and customization to potential customers.

Some existing software configuration tools may provide a user with a virtual two-dimensional (2D) or three-dimensional (3D) visualization of a building. However, such existing configuration tools may lack the capability to provide the user with an accurate, or realistic, visualization of different features or items of the building. Many existing configuration tools display a set of predefined views of the building and do not provide much flexibility to the user to experience a personalized visual perception of the building. Existing configuration tools also do not simulate the actual surrounding environment of the building. In addition, users may not be enabled by existing configuration tools to customize and/or personalize building configurations. As such, customers who have become empowered with computer graphics tools and expect high quality visualization through computer graphical user interfaces are not satisfied by existing configuration tools for use in customizing a building or home.

Furthermore, a visualization tool that merely displays a configuration of a home or a building may not be found sufficient in the housing industry for providing a platform enabling reliable interaction between different people, e.g., a customer, sales person, architect, engineer, builder, construction manager, construction worker, or the like, involved in the construction, renovation, remodeling and/or decoration of a home or building. For example, on the one hand it is useful for a customer or a sales person to be able to communicate electronically a customized configuration with an architect, engineer, builder, construction manager, construction worker, or the like. On the other hand, architects, engineers, builders, or construction people may desire to communicate electronically information relevant to building configuration to potential customers, such as different available options or choices or configuration constraints.

According to one aspect, a configuration platform, sometimes referred to herein as a “configurator,” may be used by a user to configure a home, building, interior, exterior, landscape, and so forth, while visually experiencing the changes from one or more views. The configuration platform provides several functionalities or tools related to one or more of building design and construction, displaying and visualization, building configuration and customization, pricing, interaction between multiple users, project management, collecting and providing other information related to the building such as environmental, regulatory, geographical, statistical data information, or the like. The configuration platform may also collect or provide other information, such as real-estate listings, service and maintenance information, landscaping information, energy consumption information, and any other information that may be relevant to people having interest in the building, such as customers, architects, engineers, sales people, builders, or any other individuals that may use the configuration platform. The following is a detailed description of the configuration platform, its components and functionalities, as well as a description of different implementations of the configuration platform.

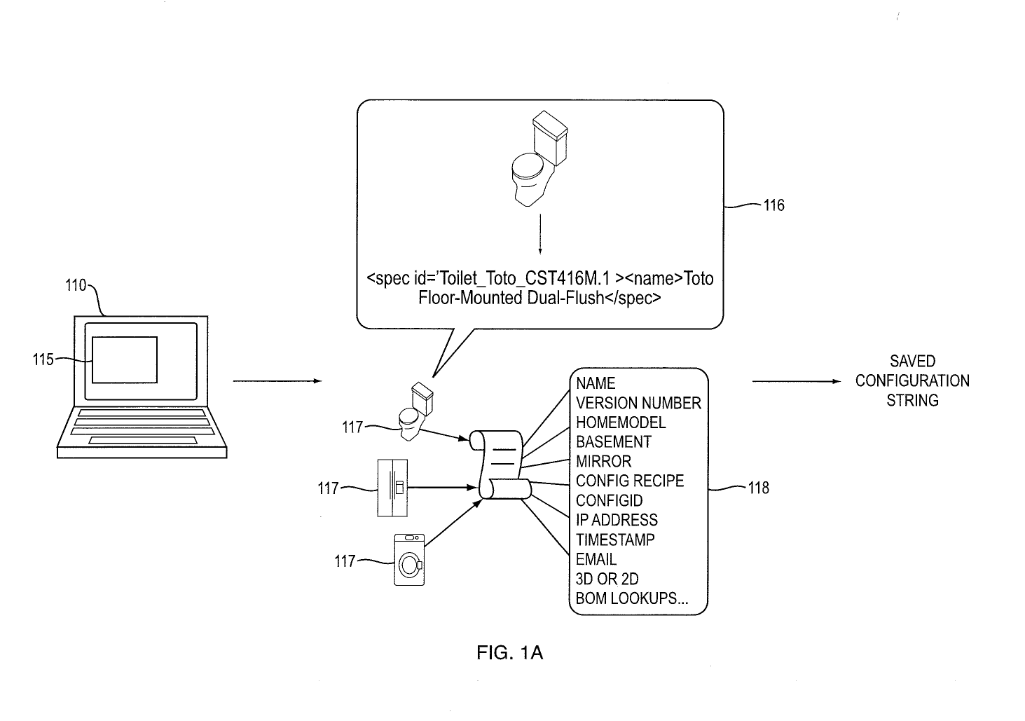

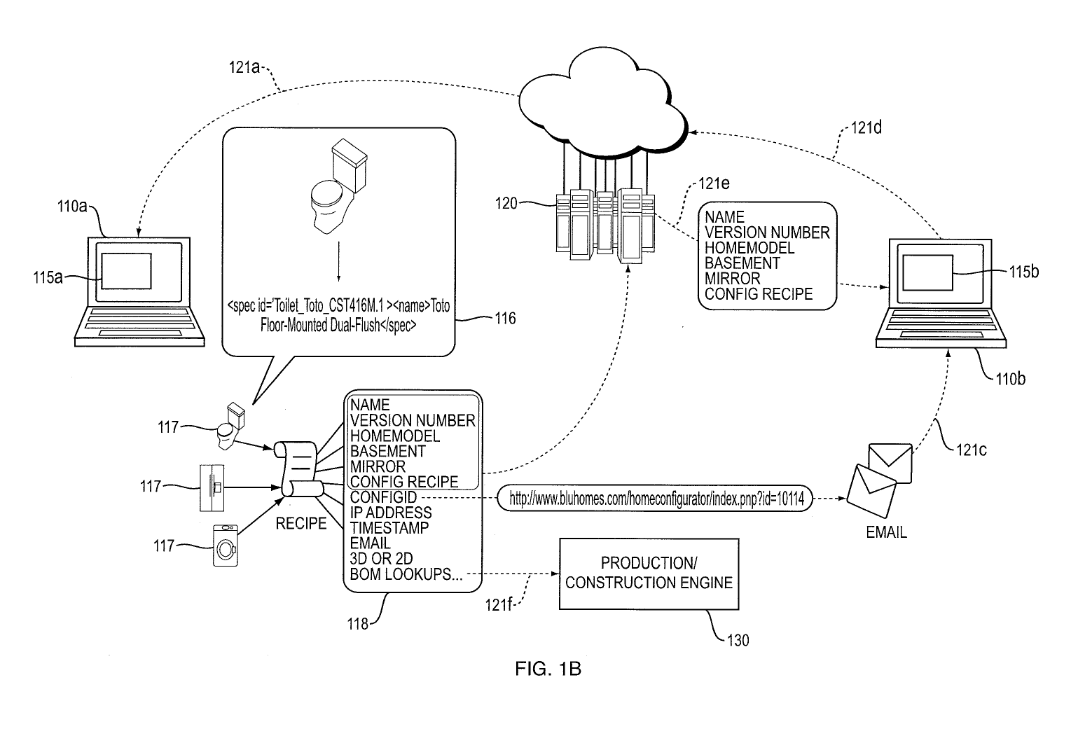

FIG. 1A illustrates an example embodiment of a configuration platform. A client device 110 has a configurator application 115 of the configuration platform operable thereon. According to the example embodiment of FIG. 1A, the configurator application 115 is a client application. A user of the client device 110 launches the configurator application 115 to visualize or customize a configuration of a building. The configurator application 115 includes, or has access to, a set of specifications 116 of physical products associated with or available to be associated with the building. The physical products 117 belong to multiple categories, and in each category, there may be one or more items described in one or more corresponding specifications. A category is a type of a physical product such as a refrigerator, stove, cabinet, tub, sink, door, window, or the like. The specifications 116 of the physical products may include specifications related to a building base model, building floor plan(s), exterior design, driveways, landscaping, basements, components of the building such as doors, windows, paint, appliances, flooring, lighting, cabinets, fixtures, or the like. The specifications 116 of the physical products may also, or alternatively, include specifications related to decoration features and products. The configurator application 115 causes the client device 110 to display a virtual representation of the configuration of the building based on a first subset of the set specifications 116 of physical products. The virtual representation may be a 3D representation, 2D representation, or combination thereof.

According to one aspect, a default subset of specifications of physical products may be used to cause a displaying of a default configuration of the building. Alternatively, a user may select one or more specifications to be included in the first subset of specifications of physical products. The configurator application 115 enables the user to navigate and customize the displayed configuration. In visualizing the displayed configuration, the user may move a viewpoint from one space area to another, e.g., from a living room to a kitchen, from a bedroom to a bathroom, from a basement to stairs, from an exterior area to an interior area and so forth. The configurator application 115 may also enable the user to move the viewpoint within one space area.

In the 3D representation, the configurator application 115 enables a “virtual walk,” where the user can control motion and orientation of a virtual viewpoint image. The virtual walk is a simulation of a virtual individual walking in the inside or outside of the building configuration. The user is further enabled to set the height of the user-controlled viewpoint. While visualizing the building configuration, the user is enabled to modify, or customize, the configuration. The user may select one or more specifications of physical products to be included in the configuration or to replace other specifications of physical products in a displayed configuration. For example, the user may select from options/selections associated with a building's base model, building floor plan(s), doors, windows, fixtures, appliances, paint, flooring, cabinets, landscaping, heating, ventilation, air conditioning, and so forth.

The user-customized configuration may be stored as a configuration recipe 118, including a plurality of tags indicative of specifications of the physical products included in the customized configuration or other information relevant to the customized configuration. Such other information includes, for example, version information associated with the set of specifications 116 of physical products, IP address associated with the client device 110, identification of the customized configuration, or the like. According to one aspect of FIG. 1A, the configurator application 115 is a stand-alone client application or a web application that may operate offline. The configurator application may be downloaded from a remote device through a communications network, e.g., the Internet, wireless network, telephony network, or the like, and installed on the client device 110. Alternatively, the configurator application 115 may be acquired through a memory medium, such as a compact disk (CD), external hard drive, flash memory, or using any other software transfer approach. The configuration recipe 118 may be stored on a memory of the client device 110, for example, as an eXtensible Markup Language (XML) document, spreadsheet document, document in another format, uniform resource identifier (URI), or the like. The stored configuration recipe 118 may be accessed at a later time by the configurator application 115 to display the customized configuration. The set of specifications 116 of physical products may also be acquired simultaneously with the configurator application 115 or separately. The set of specifications of physical products may be stored in the form of an XML document, spreadsheet document, or any other format readable by the configurator application 115.

FIG. 1B illustrates another example embodiment of the configuration platform. A first instance of the configurator application 115a operates on a first client device 110a. A first user of the first client device 110a visualizes and customizes a configuration of a building using the configurator application 115a and a corresponding set of specifications 116 of physical products. The set of specifications 116 includes different options of specifications from which the first user selects. The configurator application 115a or the set of specifications 116 may be downloaded from a server 120 through a communications link 121a. The first user may download the configurator application 115a or the set of specifications 116 from a webpage associated with the provider of the client application, from an application store, or any other Internet or network resource. The server 120 may be a computer server, remote database, network cloud, or the like. The configurator application 115a, according to one aspect, may be a client application that, once installed, operates on the client device 110a independently of the server 120. Alternatively, the configurator application 115a may access data from the server 120 while operating on the client device 110a. According to another aspect, the configurator application 115a may operate partially on the client device 110a and partially on the server 120.

The server 120 provides access for the client device 110a to download the client application 115a or data used by the client application 115a. The data, e.g., the set of specifications 116 of physical products, may be downloaded all at once, for example, simultaneously with the configurator application 115a. As such, the configurator application 115a may operate independently of the server 120. Alternatively, the configurator application 115a operates based on interaction between one or more servers 120 and one or more client devices 110a, 110b. For example, the configurator application 115a may operate mainly on the server 120, and representations of the configuration to be displayed may be streamed from the server 120 to the client device 110a as a video or animation stream. In such a case, as the first user navigates in the interior and/or exterior of the virtual representation of the building configuration information related to the navigation and/or interaction of the user with client device 110a is sent to the server 120. If the configurator application instances 115a and 115b are operating mainly on the server 120, the users of client devices 110a and 110b may configure a building in a collaborative way in real time simultaneously. Modifications made by one user are accessible to and presented to the other user by the server 120, for example.

The configurator application 115a may enable the first user to choose 2D or 3D displaying. If the 3D displaying is selected, the user is enabled to navigate within the interior or the exterior of the configuration of the building. The configurator application 115a also enables the user to set a viewpoint height so that during navigation, the virtual 3D representation is displayed according to the viewpoint height. Upon visualizing and customizing the displayed configuration of the building, a customized configuration is saved in the form of a configuration recipe 118, including information about the specifications of the physical products included in the customized configuration. The configuration recipe may be stored in an electronic document, e.g., an XML document, spreadsheet document, or document in another format, uniform resource locator (URL), or the like. If the configuration recipe 118 is stored in a URL, the URL includes a web page address from which to access or download the application and a list indicative of the specifications of physical products included in the customized configuration. The configuration recipe 118 may be stored on the server 120 through a communications link 121b and/or transmitted to a second client device 110b through a communications link 121c.

The customized configuration, or an indication thereof, may be transmitted to the second client device 110b through electronic mail, short message service (SMS), multimedia message service (MMS), chat service, social media, or any other communications means. If the configuration recipe 118 is stored on server 120, a URL including a webpage address and an identification of the configuration recipe may be sent to the second client device 110b through a communications link 121c. The client device 110b may then request and receive the configuration recipe 118 from the server 120 through the communications hyperlinks 121d and 121e, respectively. Alternatively, the configuration recipe 118 may be sent directly to the client device 110b, e.g., in the form of a URL or an XML document, through the communications link 121c. A second instance of the configurator application 115b operating on the client device 110b may then access the received configuration recipe 118 to display the customized configuration. A second user of the client device 115b is enabled to set a viewpoint height, according to which a 3D representation of the customized configuration may be displayed. The second user may apply one or more modifications to the customized configuration to generate another customized configuration that may be stored or shared with other users, such as the first user of the first client device 110a, as a second configuration recipe.

The configuration recipe 118 may also be transmitted to a production/construction engine 130 through a communications link 121f. The production/construction engine 130 may be viewed as a design, engineering, manufacturing, and/or construction system. The production/construction engine 130 translates the received configuration recipe 118 into a production/construction configuration recipe. The production/construction configuration recipe includes, for example, architectural drawings, engineering drawings, information related to plumbing, information related wall studs, information related to building structure, information related to heating, ventilation and air conditioning, information related to electric installation, information related to mechanical components, bill of materials, and the like. The production/construction configuration recipe may also include the list of specifications of the physical products included in the configuration recipe 118. The production/construction configuration recipe may be accessed and/or used by architects, engineers, construction staff, and the like in the construction, remodeling, or decoration process.

According to one aspect, the configurator application 115 is operable on a remote dedicated server. As such, users are able to explore the 3D navigation with a less powerful computer because most of the computational processing is done by the remote server. In the case of 2D displaying, the server transmits images to client devices in real-time. The server may avoid creating or producing all the images while enabling users to visualize all their selections, not just a portion of them. The configurator application 115, when running on a remote server, may create more photorealistic images because the remote dedicated server usually has a more powerful graphics card than a typical client device. The images may also be created in real time in response to user interaction with a client device.

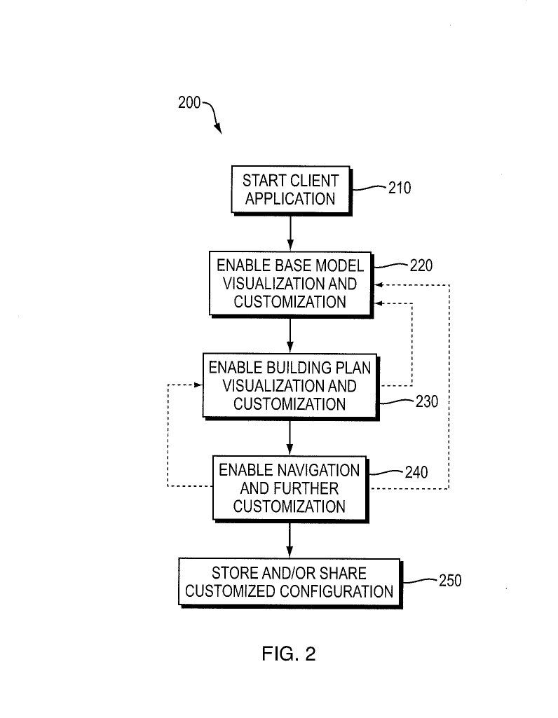

FIG. 2 is a flow chart of an example embodiment of a process 200 associated with the configurator application 115 of the configuration platform. At block 210, the configurator application 115 is started, for example, by a user of the client device 110. The configurator application 115 may be a stand-alone application or a web based application operating on the client device 110 or the server 120. At block 210, the configurator application 115 causes the client 110 device to enable visualization and/or customization of a base model of the building at block 220. For example, one or more representations and/or tabs associated with one or more base models may be displayed to the user of the client device 110, and the user is prompted to select one of the base models. Representations of base models may be 2D or 3D. Once a base model is selected by the user, the configurator application 115 causes the client device 110 to enable visualization or customization of building or floor plan(s) at block 230. For example, different options of floor plan(s) may be displayed to the user and the user is prompted to select an option. Alternatively, the user may be requested to specify, for example, the number of bedrooms or the number of bathrooms. Once the user specifies the number of bedrooms or the number of bathrooms, one or more options of floor plan(s) may be displayed to the user. Building or floor plan(s) may be displayed as 2D or 3D representations to the user. The user may be requested to select an option, or a building plan may be determined, for example, by the configurator application 115 based on the specified number of bedrooms and/or number of bathrooms.

Upon determining the building and/or floor plan(s), the configurator application 115 causes the client device 110 to present a virtual representation of a configuration of the building at block 230 and enable the user to navigate or customize the configuration of the building. The presented virtual representation may be a 3D representation, 2D representation, or combination thereof. As indicated in FIG. 2, the user may be enabled to go back to a previous operation, or block, in the process 200 to modify a previous selection or customization. For example, at block 240, the user may decide to go back and modify the selected base model, block 220, or modify the selected building plan, block 230. Similarly, at block 230, the user may decide to go back and modify the selected base model, block 220. At 250, the customized configuration is stored or shared as previously discussed with regard to FIG. 1B.

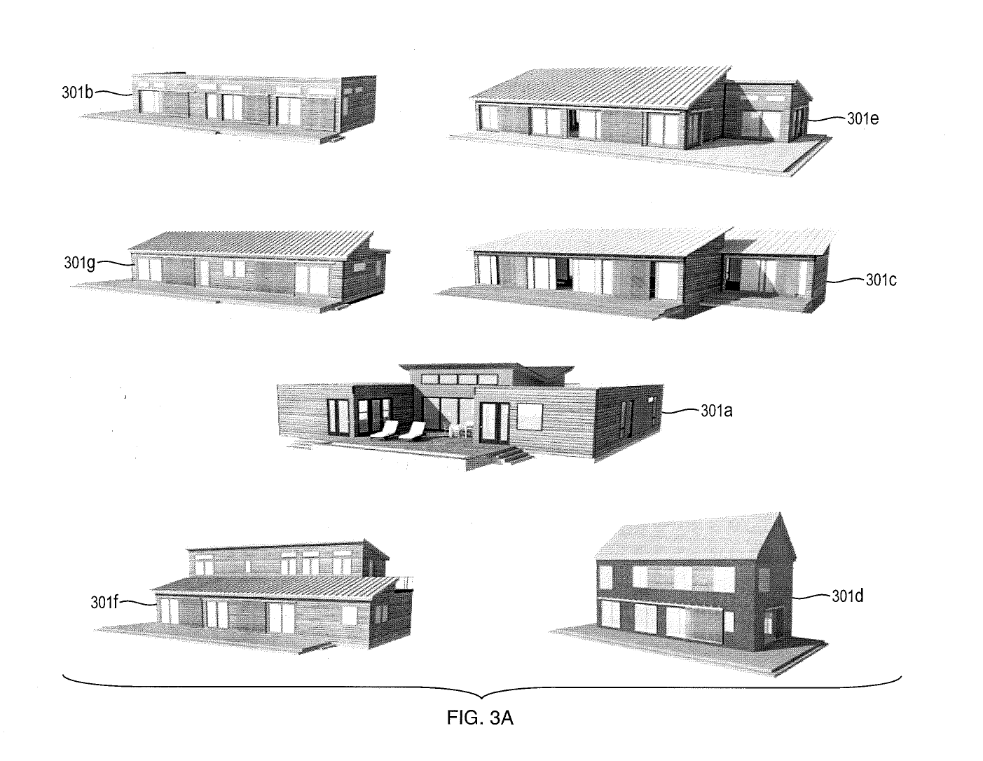

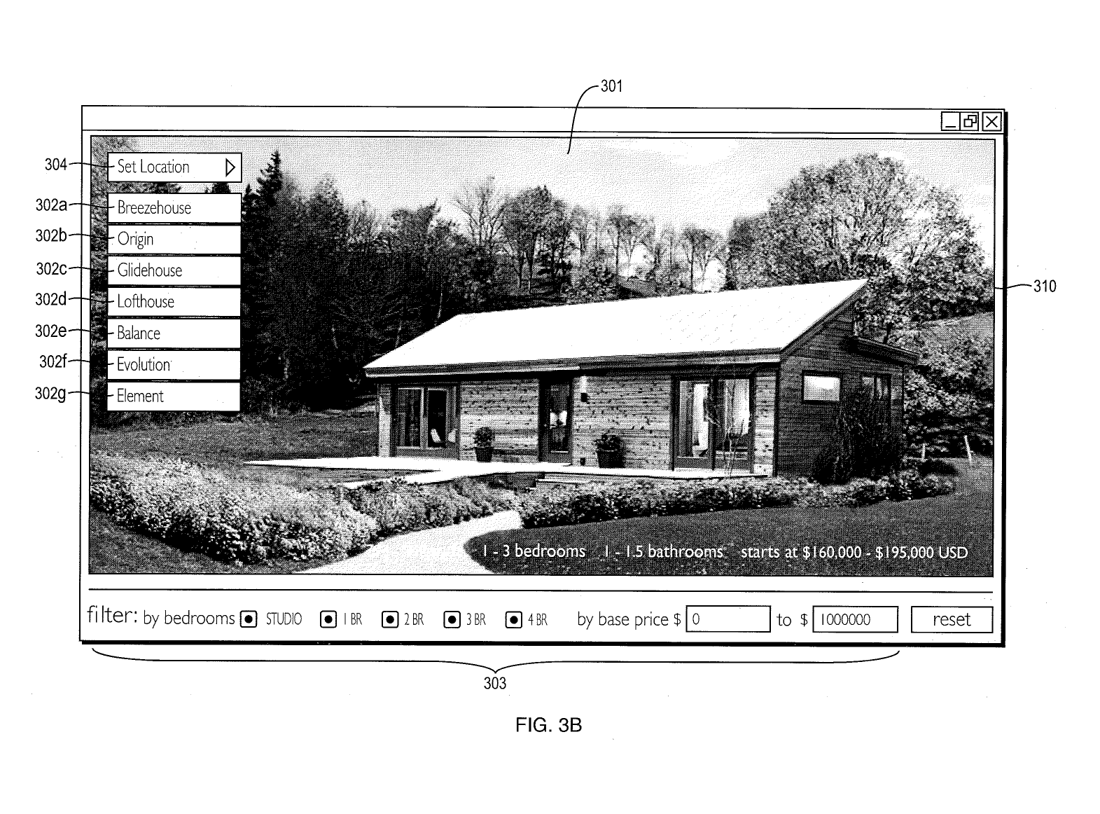

FIG. 3A illustrates an example user interface for enabling base model visualization and customization. Six representations of six different base models, namely “Breezehouse” base model 301a, “Origin” base model 301b, “Glidehouse” base model 301c, “Lofthouse” base model 301d, “Balance” base model 301e, “Evolution” base model 301f, and “Element” base model 301g, are displayed to the user. The number, the names, and the design of the base models in FIG. 3A are chosen for illustration purposes and are not to be interpreted as limitations to the scope of disclosed subject matter. The base models may be of any different number and with any other different names or designs. The user may click, tap, touch, or otherwise interact with any of the displayed representations of the base models for selection.

FIG. 3B illustrates another example user interface for enabling base model(s) visualization and customization. The configurator application 115 displays, in a visualization window 310, a representation 301 of a base model for some time interval before switching to another representation of another base model. For example, different representations of different base models may be displayed sequentially. Selectable icons/tabs, e.g., 302a, 302b, 302c, 302d, 302e, 302f, and 302g, associated with the different base models are also presented to the user. The user may select a base model by clicking, tapping, touching, or otherwise interacting with one of the icons/tabs 302a-302g. A set of filtering icons 303 may also be presented to the user. The user may select to filter the selectable or displayed base models, for example, based on a cost estimate range or a number of bedrooms. Other example filtering criteria include, for example, indoor area, number of bathrooms, number of floors, or the like. The configurator application 115 provides another icon/tab 304, which enables the user to specify the building location, e.g., a complete address or just a state or other venue identifier. The specified location may affect the cost estimate associated with a building configuration, base models options, or any other specifications of the physical products. The configuration platform may also use the user address to simulate the actual scenery around the building. The configuration platform may also map the virtual representation of the building onto the topography of the corresponding address provided by the user using a map platform, e.g., Google Earth or Bing maps.

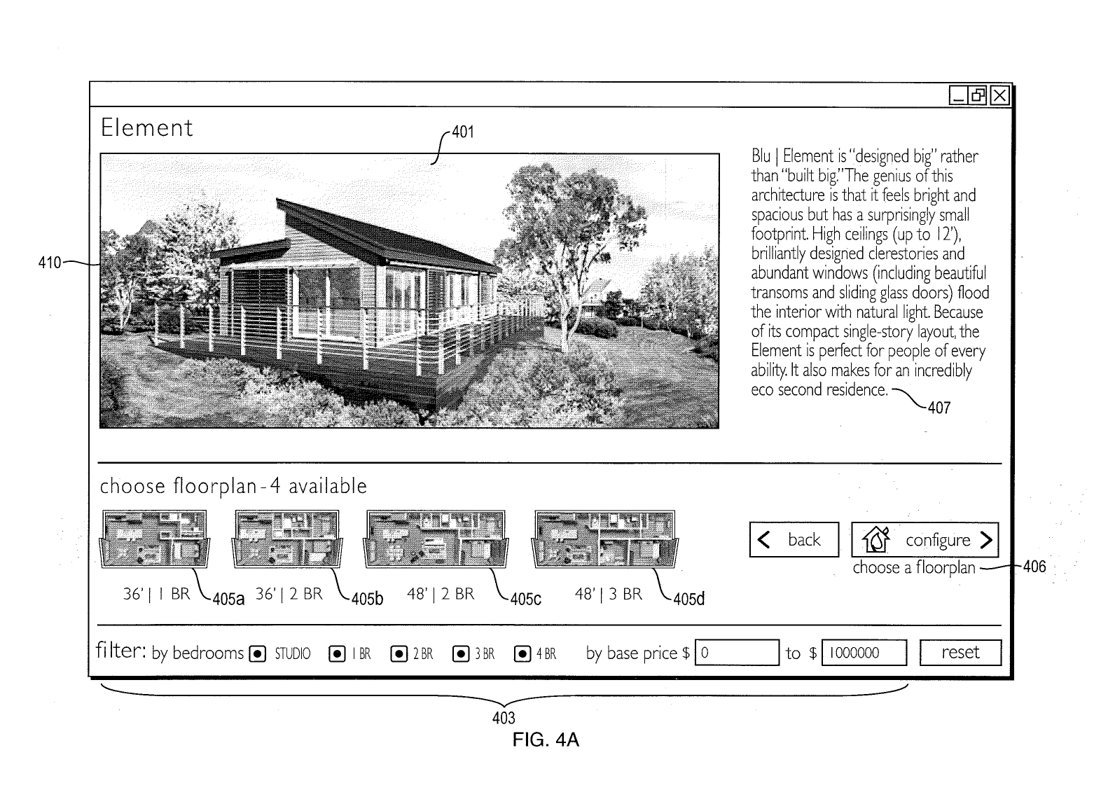

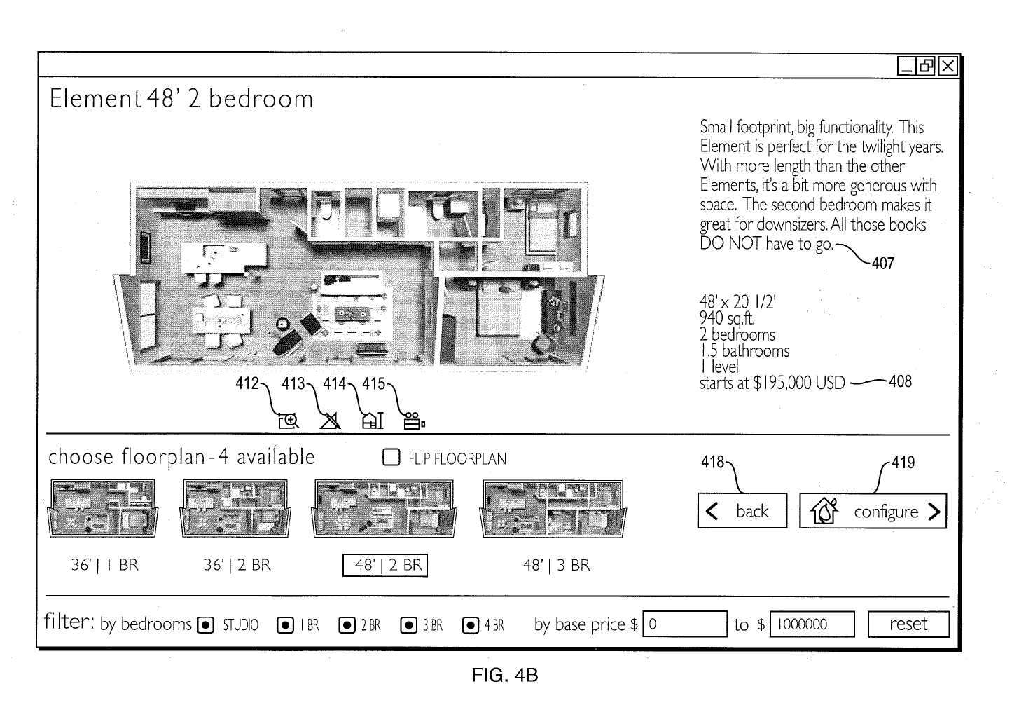

FIG. 4A illustrates an example user interface enabling the visualization and customization of building and/or floor plan(s). For example, once the user selects a base model, a representation 401 of the selected base model is then displayed in a visualization window 410. Information 407 about the selected base model may also be displayed to the user. Different representations of floor plans 405a, 405b, 405c and 405d, are also displayed to the user, and the user is prompted 406 to select a representation. A set of filtering icons 403 are also displayed to enable the filtering of the selectable or displayed floor plans based on one or more criteria, such as the number of bedrooms associated with each floor plan, area associated with each floor plan and/or one or more of the bedrooms therein, number of bathrooms, cost estimate information, or the like. The user may select a floor plan by clicking, tapping, touching, or otherwise interacting with the corresponding representation, such by tapping a keyboard key or using voice recognition interaction. The representation of the selected base model or representations of the floor plans may be in 2D, 3D, or a combination thereof. If the base model has more than one floor, each of the presented choices of floor plan(s) shows plans for all the floors. According to another example, the user may be prompted to select the number of floors in the building, for example based on representations of different building plans.

FIG. 4B illustrates an example user interface presented to the user once a floor plan has been selected to be included in the building configuration and/or for visualization purposes. The selected floor plan is displayed in the visualization window 410, instead of the previously displayed selected base model. Information 108 related to the selected floor plan is displayed, for example, together with the information 107 related to the selected base model. Other icons are provided to the user. Icon 411, for example, enables the user to flip or change the orientation of the selected floor plan. An icon 412 enables the display of an enlarged representation of the selected floor plan, whereas another icon 413 enables the display of an architectural drawing of the floor plan with corresponding measurements. Yet another icon 414 enables display of a cross sectional view of the selected view and a still further icon 415 enables initiation of a video tour or a navigation of a virtual representation associated with the selected floor plan. Once the user hass decided on a selected floor plan, he/she can move/switch to a following phase of the visualization and customization process using the icon 419. Alternatively, the user may use the icon 418 to go back to a previous stage, e.g., selection of base model. Once a base model and corresponding building and/or floor plan(s) are selected, a representation of the building configuration is displayed, and the user is enabled to navigate the displayed representation and customize the building configuration. The displayed representation may be 2D, 3D, or a combination thereof. In the case where the displayed representation is 3D or a combination of 2D and 3D representations, the configurator application 115 causes the client device 110 to enable simulation of a user-controlled virtual walk navigation.

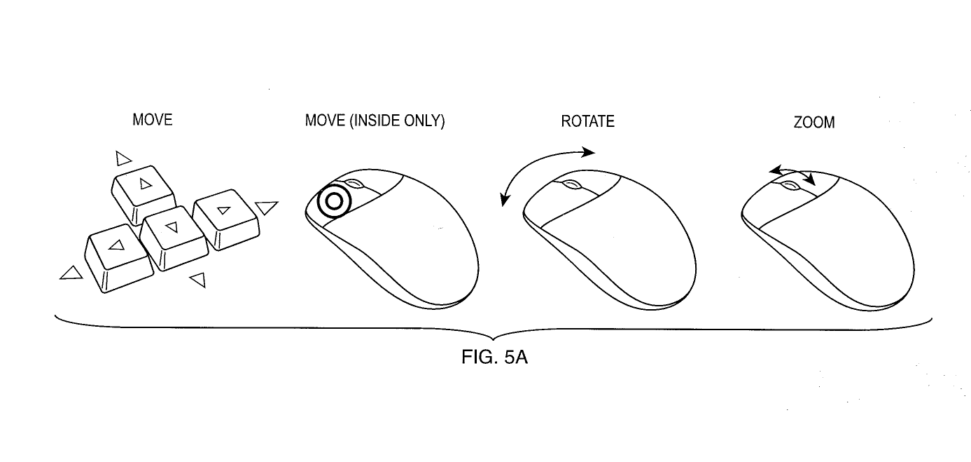

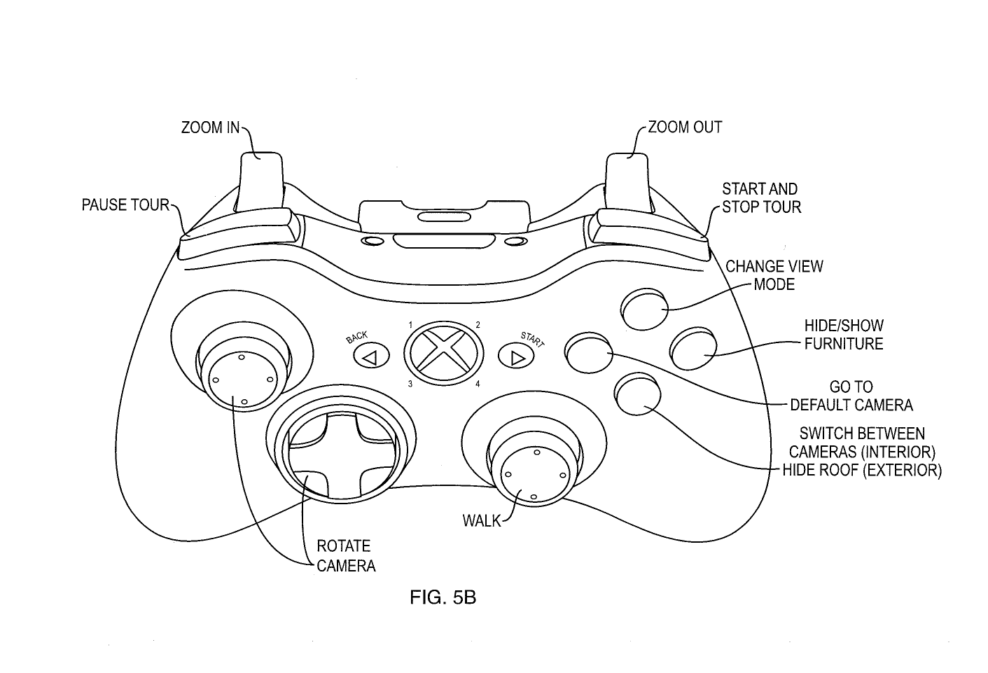

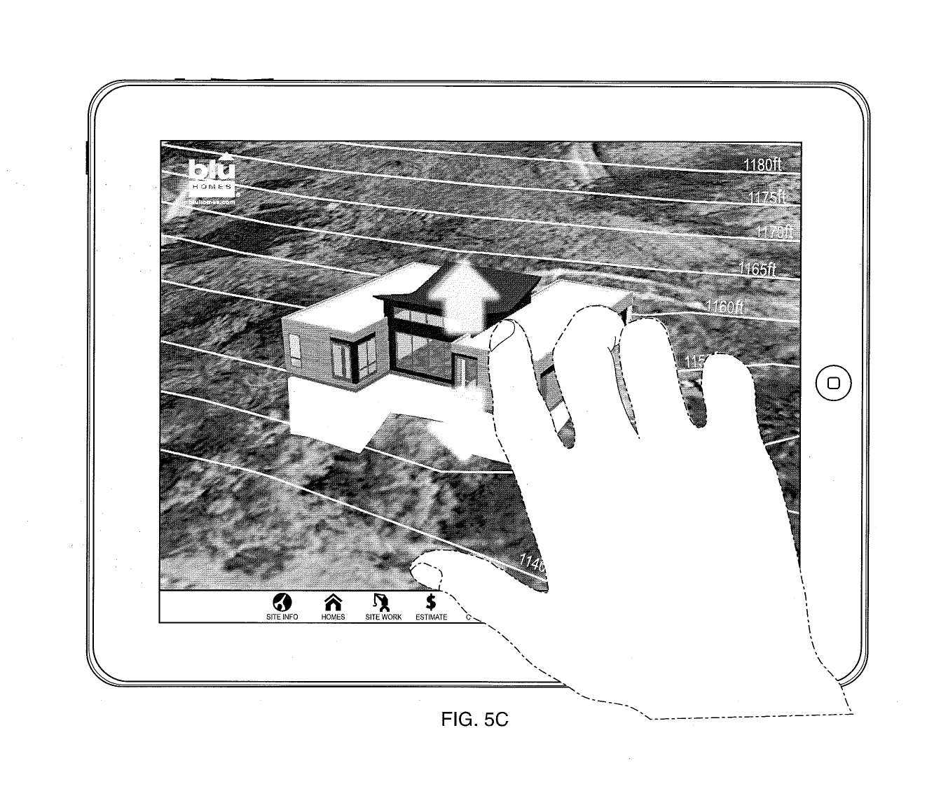

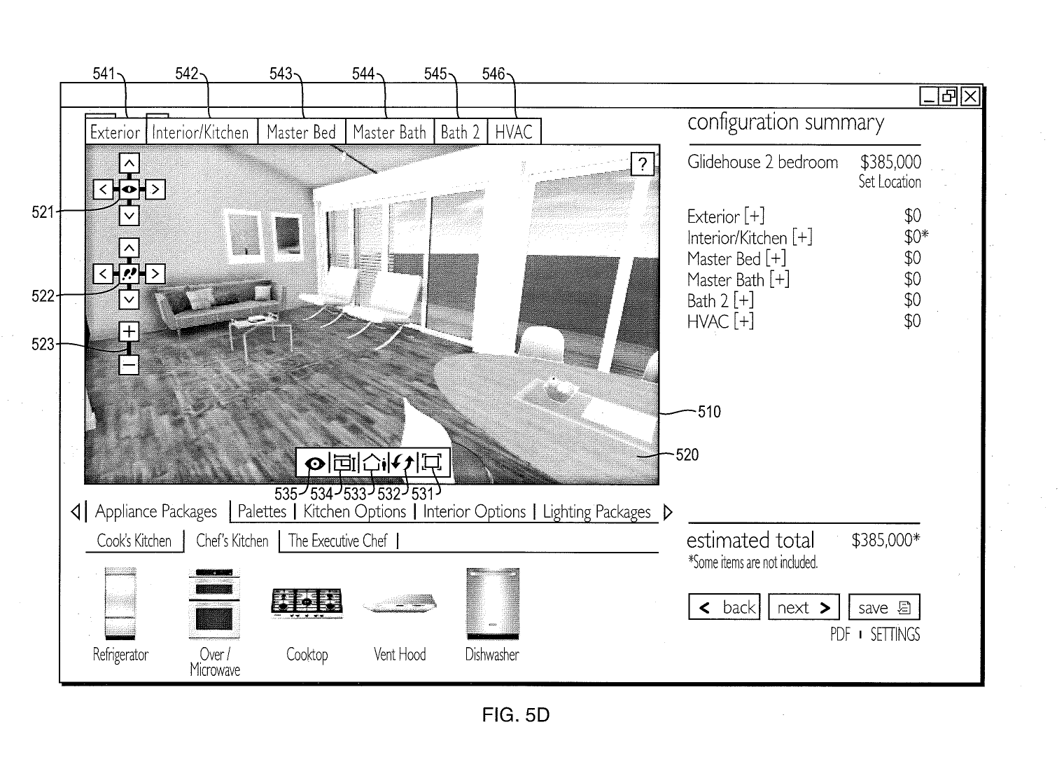

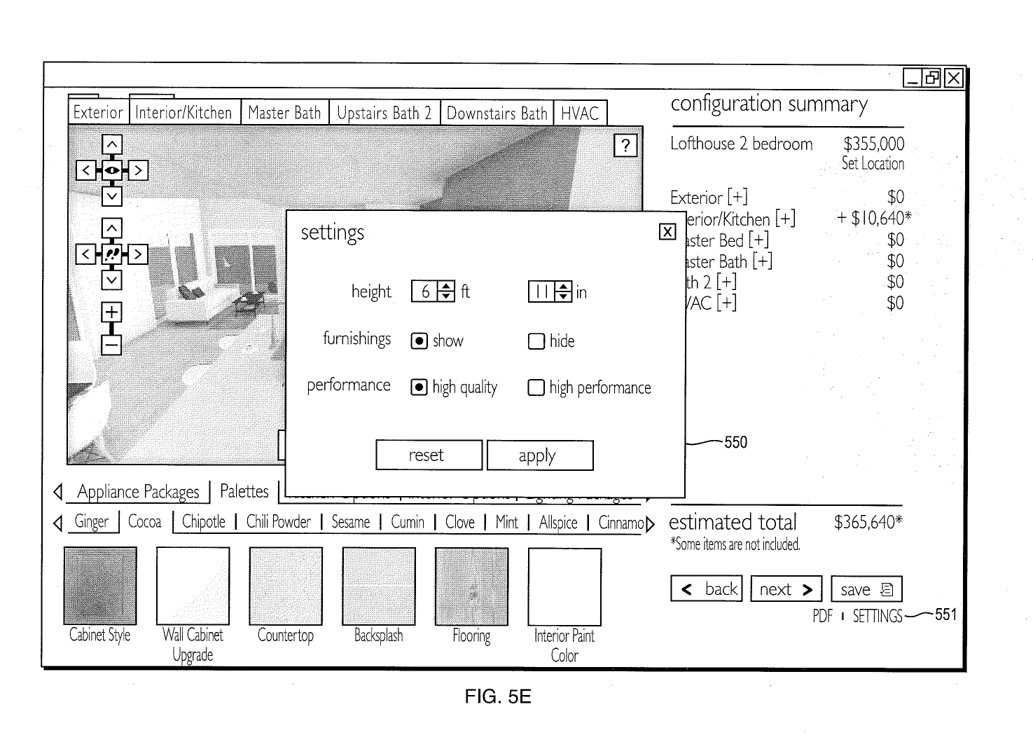

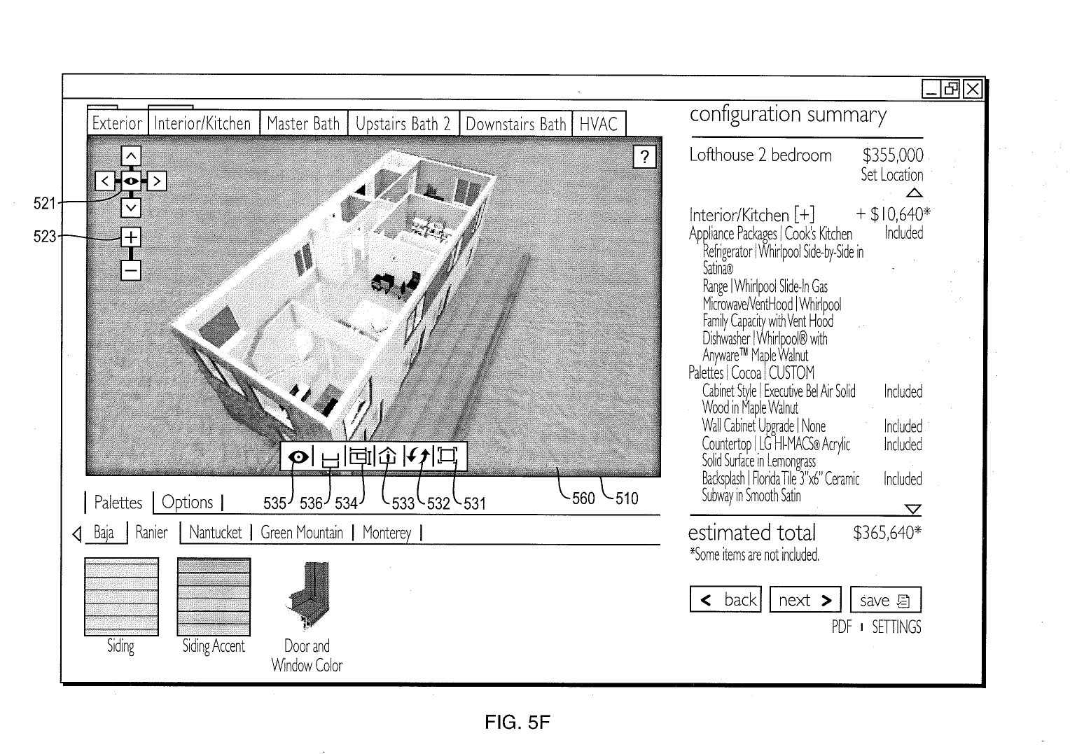

FIGS. 5A-5F illustrate example embodiments of enabling the user to navigate and visualize the building representation. According to the example of FIG. 5A, the user controls navigation and/or visualization using a computer mouse and arrow keys on the keyboard to move forward, backward, left, and right, to zoom in and zoom out and to rotate, or change the orientation of a current viewpoint. FIG. 5B illustrates an example embodiment of using a game pad to control navigation and/or visualization of the virtual representation of the building configuration. FIG. 5C illustrate an example embodiment of controlling navigation and/or visualization on a touch screen where different touching actions correspond to distinct navigation and/or viewpoint control operations.

FIG. 5D illustrates an example user interface for enabling navigation and/or viewpoint(s) control by the user in the inside of the building representation. A view 520 of the interior of the building representation is displayed in a visualization window 510. An eye icon 521 having four different arrows around it is presented to the user. By operating on one of the arrows, the user can rotate a current viewpoint upward, downward, left, or right. Alternatively, the user may perform the same rotation by clicking on the left mouse button, for example, while the cursor is within the visualization window 510 and simultaneously moving the mouse left, right, upward, or downward. On a touch screen, the user may touch the visualization window with a finger and move the finger in one of the left, right, upward, or downward directions. The icon 522 showing two feet has also four arrows around it to enable moving forward, backward, left, and right in virtual walk navigation. The icon 523 has plus and minus signs used, respectfully, to zoom in and zoom out a current view. Icon 531 enables a full screen display of the representation 520. Icon 532 is used to initiate a predefined virtual tour of the representation of the building. icon 533 enables moving from a current interior view to an exterior view of the representation and vise versa. Icon 534 enables displaying the floor plan in the visualization window 510 instead of the representation 520. Icon 535 enables display of the available predefined views that the user can switch to in the visualization window 510. Such predefined views correspond, for example, to different space areas and/or physical products associated with the representation of the building configuration. The predefined views can also be accessed by operating on one of the tabs 541-546.

FIG. 5E illustrates an example embodiment of enabling a user to set a viewpoint height for virtual walk navigation. A “SETTINGS” tab 551 is presented to the user. In response to the user operating on the tab 551, a pop-up window is displayed to the user. The pop-up window enables the user to select or specify a viewpoint height. The pop-up window may also enable activating/deactivating other features such as adding/removing furniture to/from the representation of the building configuration or switching between a high visualization quality mode and a high/fast processing performance mode of the configurator application 115. By setting the viewpoint height, the displayed views of the building configuration representation are determined according to the potential visualization experience of a virtual person performing the virtual walk and having the same height as the set viewpoint height. Alternatively, the displayed views may be determined according to a virtual camera moving along the virtual walk path and being at the same height as the set viewpoint height.

One of the advantages of the feature of enabling a user to set the viewpoint height is to simulate a realistic user visual experience. In other words, when specifying his/her own height as the viewpoint height, a user gets a realistic feeling of how he/she would visualize the different features and/or physical products in the building configuration. In addition, a user may set the viewpoint height as the height of one of his family members to simulate the respective potential visual experience. According to other aspects, the “SETTINGS” tab 551 enables the user to select and/or specify lighting condition(s). For example, “Day Time” and “Night Time” icons may be presented to the user within the “SETTINGS” pop-up window or even listed under a separate tab. Following the user's selection of one of the presented choices, for example, by operating on a corresponding icon, the respective lighting condition, e.g., day light or night light, is simulated when displaying the virtual representation of the building configuration.

According to another aspect, the “SETTINGS” pop-up window may include other settings options related to depth of field or field view when displaying virtual 3D representation. Other options may, for example enable visualization of sunlight, street light, or moon light. Setting sunlight visualization may be in correlation with a time during the day and optionally a corresponding date. Setting moonlight visualization may be in correlation with a specified date.

According to another aspect, the user is enabled to visualize the sunlight at a given viewpoint. The user specifies a location of the building, orientation of the base model, or combination of both. The configurator application 115 causes the simulation of sunlight when displaying the virtual representation of the building configuration. The user is then enabled to visualize, for example, sunlight penetration in the virtual representation of the building configuration from different viewpoints, or while navigating the virtual representation. A bar, for example, may also be displayed to the user illustrating a measure of sunlight penetration into the virtual representation of the building.

FIG. 5F illustrates an example embodiment of enabling navigation and visualization in the exterior of the building configuration. An exterior view 560 of a virtual representation of the building configuration is displayed in the visualization window 510. A new icon 536 enables the user to hide the roof, hide an upper floor, or unhide the upper floor and the roof in the displayed view 560 of the exterior of the building configuration. For example, the displayed view 560 shows a virtual representation of the building configuration without the roof. By operating on the icon 536, another view is displayed showing a virtual representation of the building configuration with only the first floor, e.g., no roof and no second floor. If the user operates once more on the icon 536, another view is displayed showing a virtual representation of the building configuration with all floors and the roof. One of the advantages of such feature is to provide the user with multiple perspective views of the building configuration. According to other aspects, the user is enabled to remove a portion of the virtual representation of the building. The portion may be a wall, a ceiling, an upper floor, furniture, or any other part or component.

In the visualization window 510, only icons 521 and 523 are provided, whereas icon 522 is not. In another example, icon 522 may also be provided, thereby enabling a virtual walk in the exterior of the building configuration also. The icons 521 and 523 have the same functionalities as described with regard to FIG. 5D. The use is user is also enabled to move between the inside and the outside of the virtual representation in virtual walk navigation.

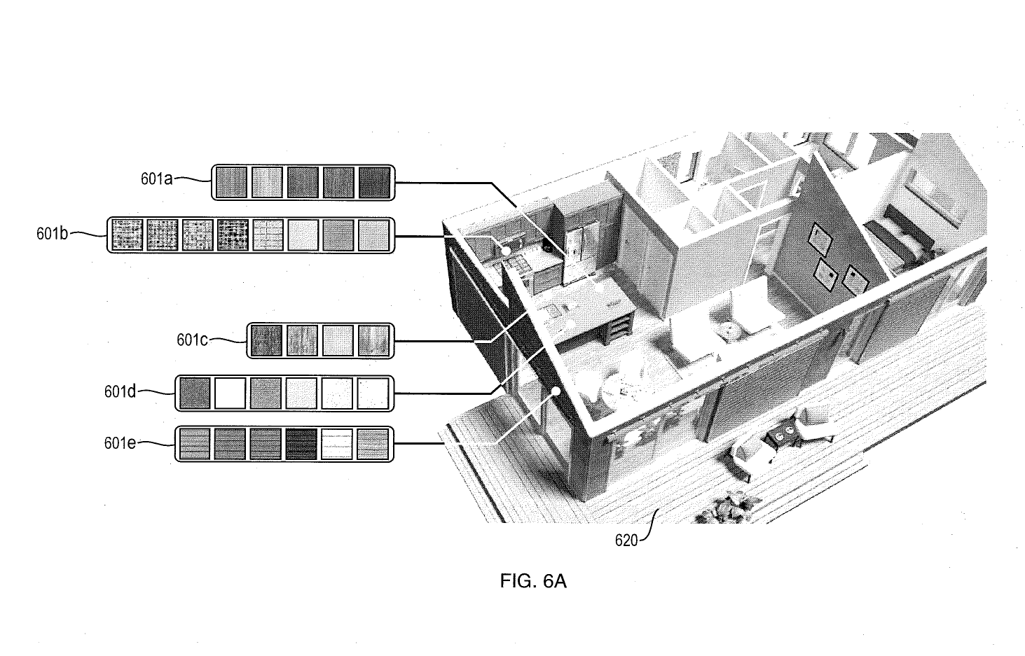

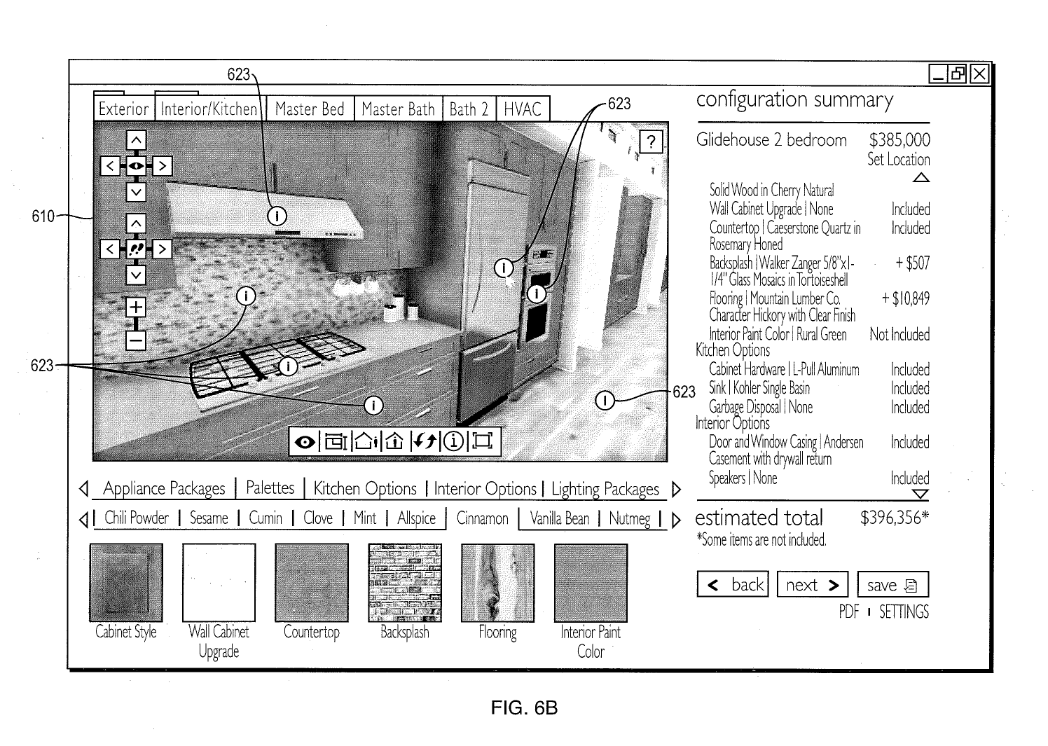

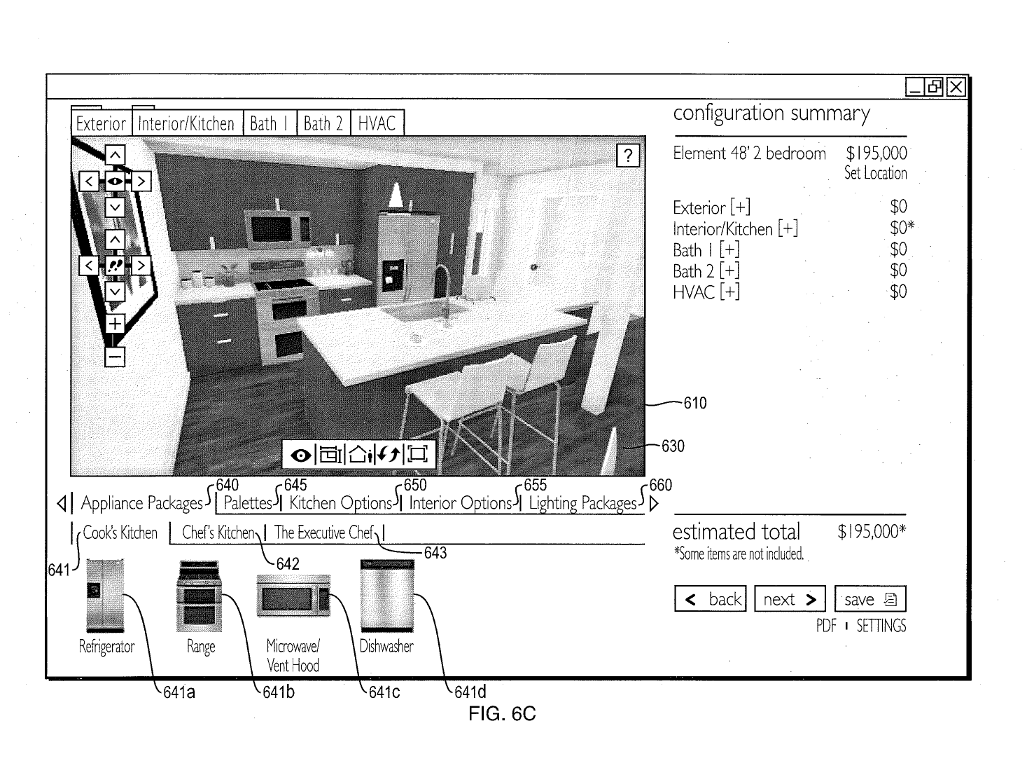

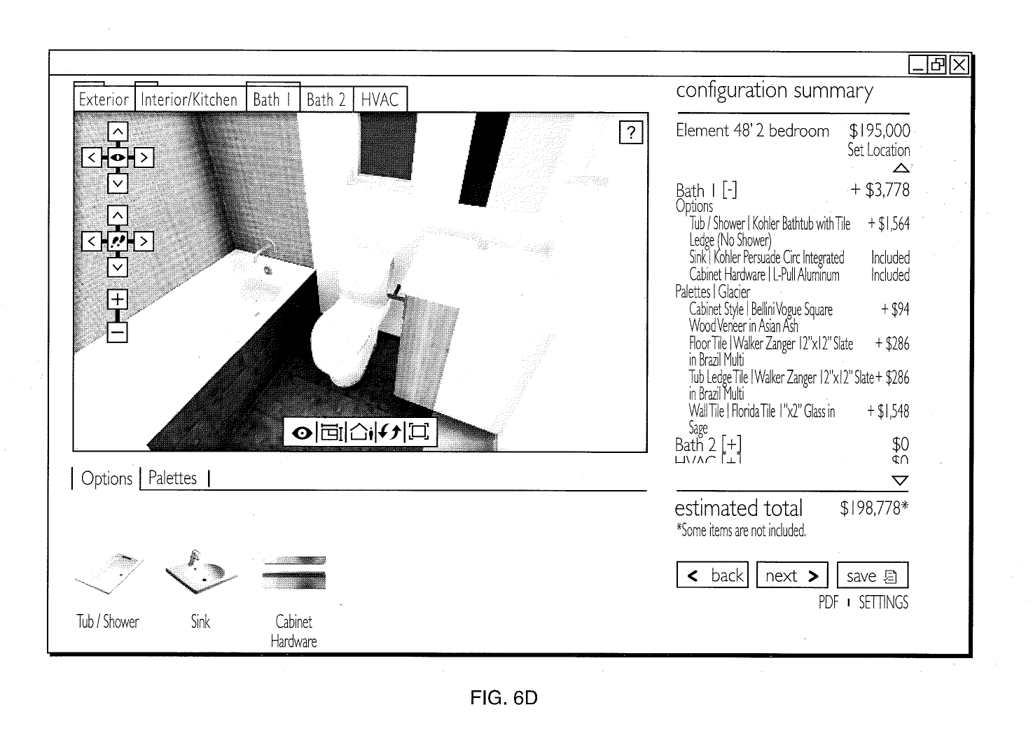

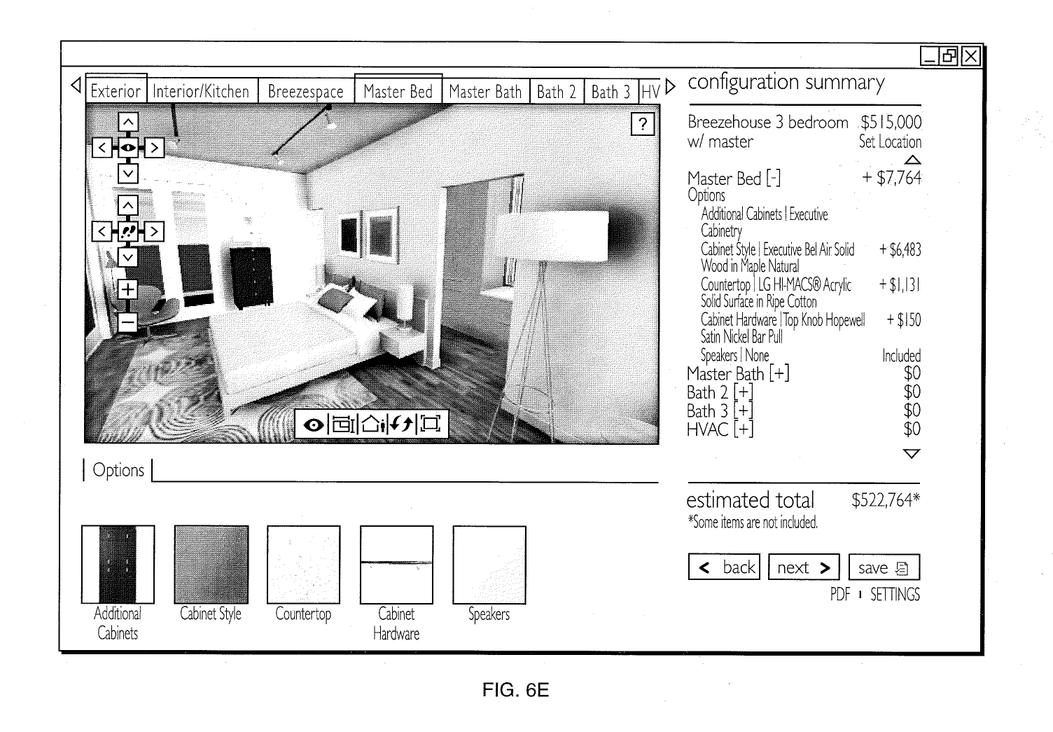

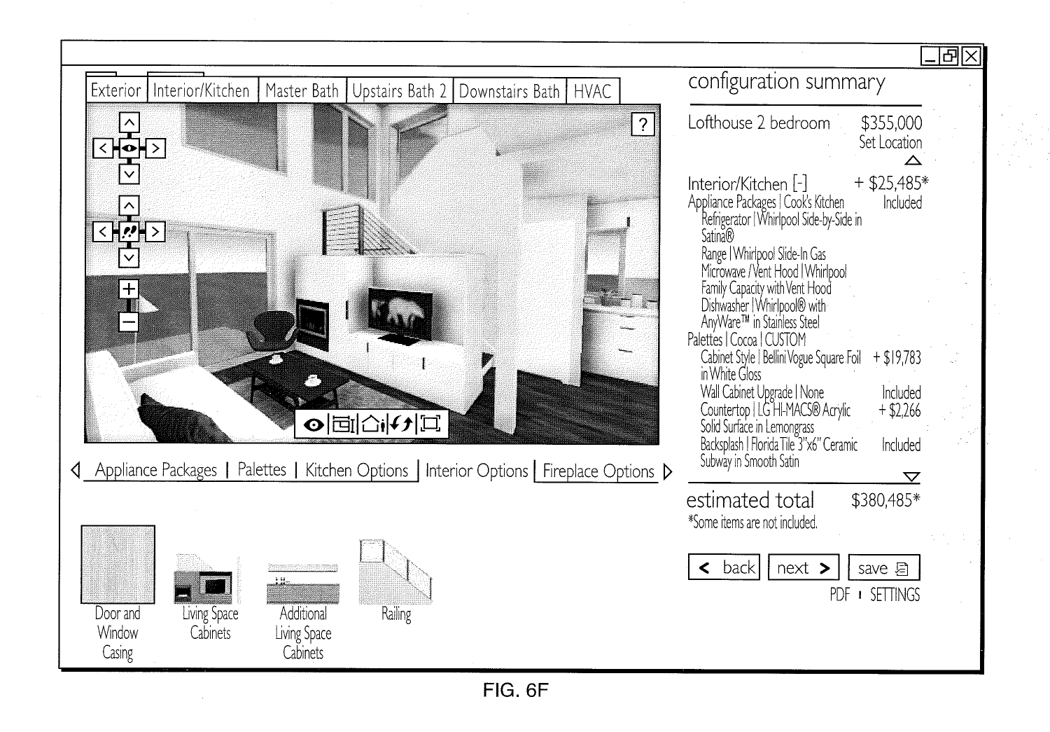

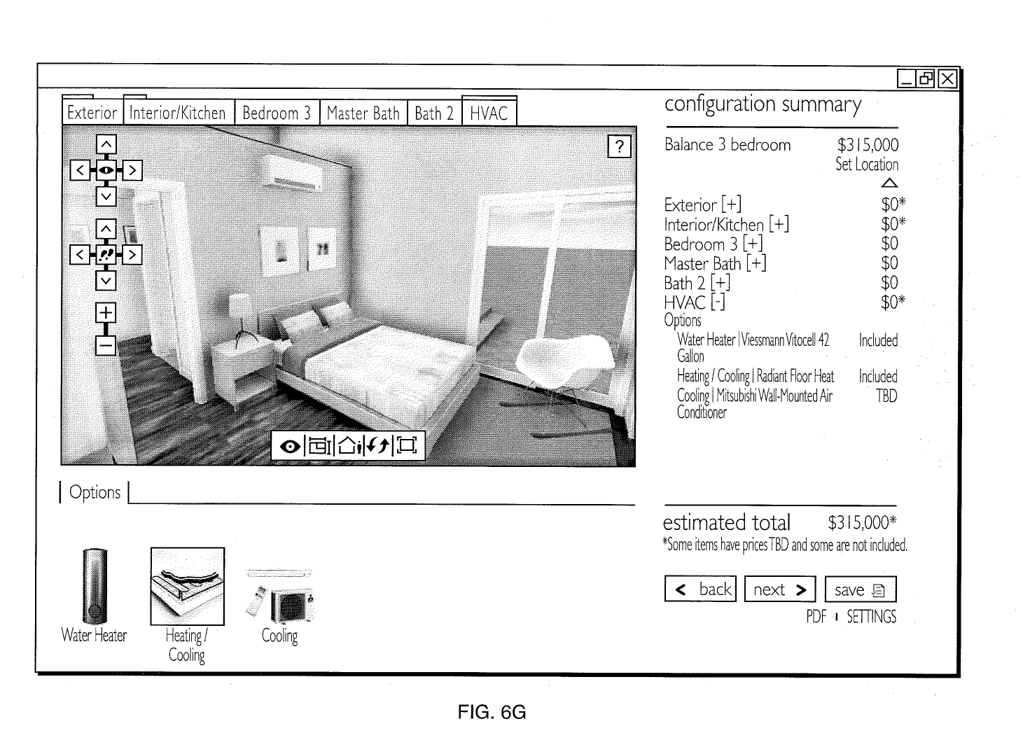

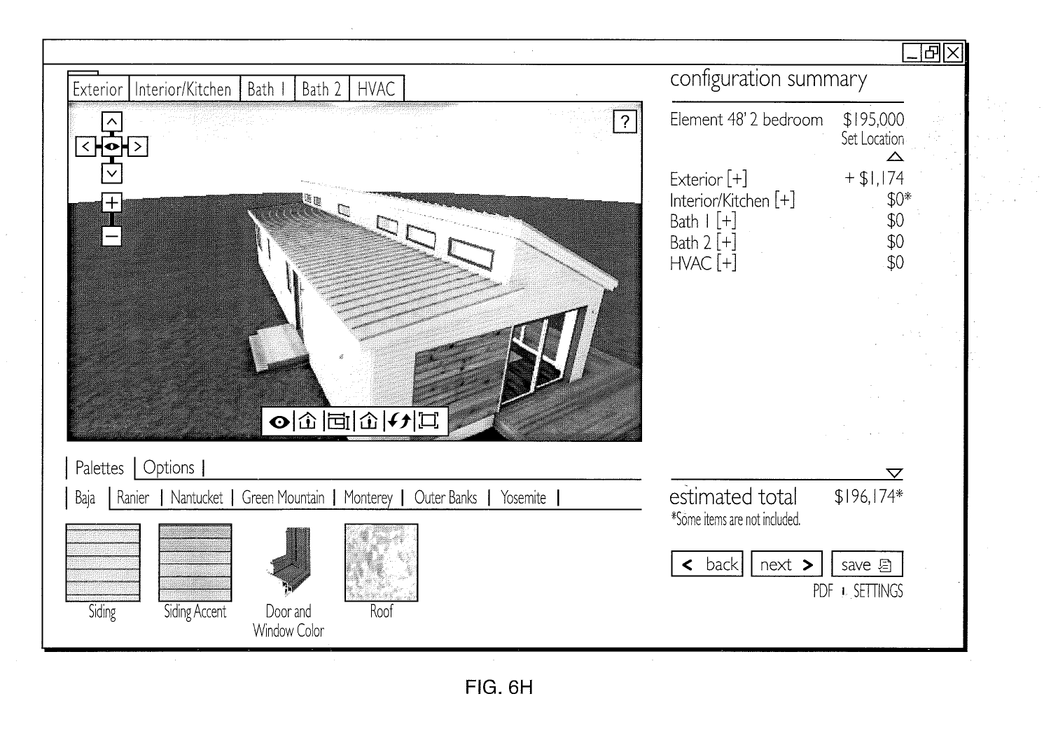

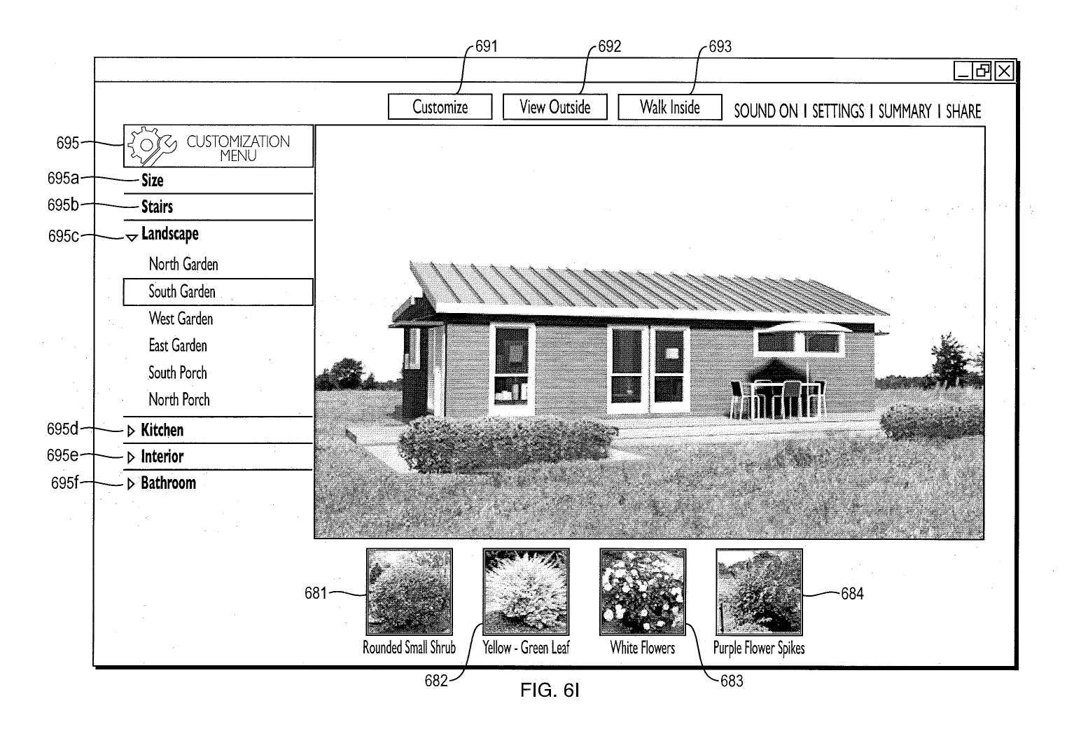

FIGS. 6A-6I illustrate different example embodiments of enabling customization, or modification, of the displayed building configuration. In FIG. 6A, for example, a view 620 of the representation of the building configuration is displayed together with a plurality of sets, 601a, 610b, 601c, 601d, 601e, of texture and/or color choices associated with a plurality of physical products, or items, in the building configuration. For example, the set 601c represents different options of floor texture and/or color, whereas the set 601e describes different texture and/or color options for exterior walls. According to one aspect, the sets of texture and/or color options may be displayed to the user as an illustration of the different available texture and/or color choices associated with one or more physical products. According to another aspect, the presented texture and/or color options in each of the sets 601a through 601e correspond to active icons on which the user can operate on to modify the texture and/or the color of a corresponding physical product.

FIG. 6B illustrates another example embodiment of a user interface enabling customization, or modification, of the displayed building configuration. A view 620 of a space area, e.g., kitchen, in the building configuration is displayed in the visualization window 610. Navigation and visualization icons 512, 522, and 523 are presented to the user as the customization is enabled while navigation, or virtual walk, is enabled. In other words, while a user is navigating and visualizing a representation of the building configuration the user is enabled to customize and/or modify specifications of physical products in the building configuration. Different graphic icons 623, coupled to physical products shown in the displayed view 620 are also presented to the user. Upon the user operating on an icon 623 associated with a physical product category, e.g., a refrigerator, a stove, a wall, floor, and/or the like, information and/or different specifications related to the same physical product category are displayed to the user and the user is enabled to select a choice or a specification associated with the physical product category. For example, when the user clicks, touches, or puts a cursor on the icon 623 shown on the refrigerator representation alternative refrigerator representations are displayed to the user. Upon the user operating on, or selecting, one of the displayed refrigerator representations, the selected representation is then displayed with the displayed view 620. Different refrigerator representations may be, for example, 2D images or 3D representations of different refrigerator models and/or brands. Other information related to each model and/or brand such as price information, description information such as weigh and dimensions, and/or the like may also be provided to the user.

FIG. 6C shows yet another example user interface enabling customization, or modification, of the building configuration. A view 630 of a space area, e.g., kitchen, of the building configuration is displayed in the visualization window 610. Different customization tabs, e.g., 640, 645, 650, 655, and 660, are presented to the user. Three other tabs 641, 642, and 643 are associated with, or listed under, the tab 640, named “Appliance Packages”. The tabs 641, 642, and 643 represent different choices of appliance packages. A package is a default or preconfigured group of specifications of different physical products that is presented to and selectable by the user as a group. In other words, it is a preconfigured group of specifications of physical products where 2D and/or 3D representations corresponding to the group of specifications are displayed together as a group to the user. The user may decide to select the whole group or not, but the user may not select one or more items that do not constitute the whole group. For example, the package represented by the tab 641 includes four physical product specifications, e.g., associated with specific brand and/or model, of a refrigerator, a range, a microwave/vent hood, and a dishwasher.

When the user operates on the tab 641, 2D and/or 3D representations 641a, 641b, 641c, and 641d, of the specific physical products are displayed to the user. Also by operating, or placing a curser, on the tab 641, the price of the corresponding package and/or a difference amount with respect to the respective package currently included the building configuration is displayed to the user. The number and the type of the physical products listed under the package represented by tab 641 describe an example for illustration and are not to be interpreted in a way to limit the scope of disclosed subject matter. The user may select one of the different appliance packages, e.g., for the kitchen, represented by the tabs 641, 642, or 643. When the user operates on one of the tabs 641, 642, or 643, the displayed view 630 changes in a way to show the representations, corresponding to the specifications of the physical products in the respective package, integrated in the view 630. Therefore, as the user navigates the virtual representation of the building configuration and customizes, or modifies, specifications of physical products included in the building configuration the customizations, or modifications, are shown instantly to the user. Additional information related to the items in the respective package is displayed to the user. Such additional information, for example, includes the brand and/or model of one or more items in the respective package, description of features of the one or more items, a change amount in a cost estimate, and/or the like. Such information allows a user to make an educated selection Links associated with one or more items in the respective package may also be presented to the user, for example, to access further information.

The tab 645, named “Palettes”, represents other groups of specifications of physical products. For example, by operating on the tab 645, new tabs instead of 641, 642, and 643, are displayed to the user. The new tabs, for example, correspond to groups of specifications of physical products such as interior paint, flooring, backsplash, countertop, wall cabinet, and cabinet style. When the user operates on any of the new tabs, 2D and/or 3D representations corresponding to the specifications of the physical products in the respective palette are displayed to the user. Also by operating, or placing a curser, on the tab 645, the price of the corresponding palette and/or a difference amount with respect to the respective palette currently included the building configuration is displayed to the user. The displayed view 630 also changes to show the representations, corresponding to the specifications of the physical products in the respective palette, integrated in the view 630. The change in the view 630 may occur upon the user operating on the one of the new tabs once or twice, or upon operating on another tab/or icon indicative of selection of the respective palette. Further information related to the items in the respective palette is displayed to the user. Such additional information, for example, includes the brand and/or model of one or more items in the respective palette, description of features of the one or more items, a change amount in a cost estimate, and/or the like. Such information allows a user to make an educated selection. Links associated with one or more items in the respective palette may also be presented to the user, for example, to access even further information.

Palettes are different from packages. While default packages are non-modifiable by users, a user can modify a default or preconfigured palette to obtain a customized palette. The default palette may still be accessible to the user while the customized palette is accessible, for example, as a custom palette. In other words, palettes provide more flexibility to the user. Packages and palettes offer an innovative way to help the user be more efficient when configuring the user's home.

The options tab 650, e.g., “Kitchen Options”, represents one or more physical product categories, e.g., associated with the kitchen, that are independently customizable. For example, by operating on tab 650, 2D and/or 3D representations, tabs, or icons associated with one or more physical product categories are presented to the user. Such physical product categories include, for example, cabinet hardware, sink, garbage disposal, and/or the like. The user operates on one of the presented representations, tabs, or icons to customize or modify an item corresponding to the respective product category or to seek display of information related to an item, corresponding to the respective product category, currently included in the building configuration. If the user operates on the representation, tab, or icon associated with the sink physical product category, for example, two tabs are then displayed to the user indicative of modifying or simply requesting details information. If the user selects to request details information, information about the sink already included in the building configuration is displayed to the user.

However if the user selects to customize the sink or explore other available sink specifications, representations corresponding to different sink choices are displayed to the user and the user is enabled to select one of the displayed choices. Also by operating, or placing a curser on a representation, tab, or icon associated with a choice related to a category to be customized, the price of the corresponding choice item and/or a difference amount with respect to the respective item currently included the building configuration is displayed to the user. The configurator application also changes the view 630 currently displayed in the visualization window 610 to show a preconfigured view associated with the product category to be customized. According to one aspect, each physical product category that is individually customizable, e.g., not within a package or palette but rather listed under an options tab, has one or more preconfigured views associated with it. As the user selects to customize a product category that is individually customizable, the corresponding preconfigured view is displayed in the visualization window 610. The preconfigured view associated with the product category to be customized may be configured, for example, in a way to provide a clear and good view of the features of an item in the product category.

The options tab 655, named “interior options”, is indicative of one or more other physical product categories that are individually customizable. As the name indicates, such categories relate to the interior of the building configuration and include, for example, different choices for door and window casings. The kitchen and interior, or living room, may be grouped together or presented separately depending, for example, on a respective floor plan. If the user operates on the tab 655 and/or representations, icons, or tabs, listed there under, a corresponding preconfigured view is shown in the visualization window 610. The tab 660, named “Lighting Packages” represents different selectable preconfigured packages of lighting items.

FIGS. 6D through 6H show user interfaces, similar to FIG. 6C, enabling customization of a bathroom, a bedroom, a living room, HVAC, and exterior, respectively. The customization process is similar to what is described above, however the available packages, palettes and/or options change may differ based a current space area, a current base model, a current building and/or floor plan(s), and/or other factors. For example, in FIG. 6D the physical product categories that are individually customizable, e.g., listed under options tab, are specific to the bathroom. Also no packages are available with regard to the bathroom in FIG. 6D. In FIGS. 6E and 6G, only one options tab is available but no palettes or packages. It is to be noted that FIGS. 6C, 6D, and 6H show space areas associated with a building configuration with “Element” base model 301g and a building/floor plan with two bedrooms, whereas FIG. 6E shows a space area corresponding to a building configuration with “Breezehouse” base model 301a and building/floor plan(s) having 3 bedrooms, FIG. 6F shows a space area corresponding to a building configuration with “Lofthouse” base model 301d and building/floor plan(s) having 2 bedrooms, and FIG. 6G corresponds to a building configuration with “Balance” base model 301e and building/floor plan(s) having 3 bedrooms. As such, available selectable palettes, packages and/or options may change based on the respective base model, building/floor plan(s), location, filter metrics such as a specified cost estimate range, and/or any other factors.

In FIG. 6D, for example, the user may customize one of the categories illustrated with the representations 671, 672, 673, and then navigates away from the customized item and/or the corresponding space area, e.g., Bathroom 1. In order to get back to the viewpoint associated with the last customized category, the user simply operates on the corresponding representation, e.g., one of the representations 671, 672, and 673. In another example implementation, the configurator application may display one or more icons, tabs, and/or representations associated with the last one, or few, customized categories and upon the user operating on one of the displayed icons, tabs, and/or representations the corresponding viewpoint is displayed to the user in the visualization window 610.

FIG. 61 shows a user interface, different from FIGS. 6C through 6H, to enable customization of a building configuration. According to one aspect of FIG. 61, a customization mode is indicated by tab 691 and a visualization mode is indicated by the tabs 692 and 693 corresponding, respectively, to visualization of the exterior and the interior of the virtual representation of the building configuration. When the customization mode is activated, a customization menu 695 is displayed to the user. The customization menu describes a list of menu items, 695a to 695f, representing customizable features and space areas of the building configuration, namely the “Size” of the building 695a, the “Stairs” 695b, the “Landscape” 695c, the “Kitchen” 695d, the “Interior” 695e, and the “Bathroom” 695f. In FIG. 61, the

“Landscape” item 695c is selected by the user and different selectable sub-items, namely “North Garden”, “South Garden”, “West Garden”, “East Garden”, “South Porch”, and “North Porch” are presented to the user and view 680 of the selected “South Garden” is displayed to the user. A set of selectable single plant and/or flower options, 681, 682, 683, and 684, are also presented to the user for customization of the “South Garden”. According to the same aspect of FIG. 61, landscaping packages and/or palettes may also be presented to the user in one or more of the sub-items listed under the “Landscape” item 695c. It is to be noted that the sub-items listed under item 695c, their number and their names are described in this application as an illustrative example and are not to be interpreted as limitations to the scope of subject matter.

The user may at any point of the customization decide to go back and modify the current building base model and/or the floor plan(s). For example, the user may customize one or more physical product categories and then decides to go back and modify the current building base model and/or the floor plan(s), e.g., by operating the back tab in FIGS. 6C to 6H. According to one aspect, information about selected specifications corresponding to the one or more customized physical product categories is deleted and the user has redo the customization, or selection of specifications, in the new selected base building base model and/or floor plan(s). According to another aspect, the configurator application 115 enables keeping the previous customizations, or specifications' selections, of the user while modifying the selected building base model and/or floor plan(s). If one or more of the previous customizations made by the user are not compatible with the new selected base model and/or floor plan(s), the configurator application 115 may simply use corresponding default specifications instead of the one or more non compatible customizations or prompt the user to make alternative selections.

According to other aspects, a building configuration is described as a set of selections made by a user. These selections represent a full description of what the built, renovated, remodeled, and/or decorated building would look like. As illustrated by FIGS. 6A through 61, user selections are made by browsing through a finite set of physical product categories, and selecting among available physical product specifications for each of these categories. Example of physical product categories include a base model, a building and/or floor plan(s), wall paint(s), door(s), window(s), bath tub(s) and/or shower(s), sink(s), refrigerator(s), cabinet(s), cabinet hardware, plant(s) and/or flower(s), stairs railing(s), and/or the like of physical products usable in buildings. Each category offers a list of available specifications. The configurator application 115 may present one or more physical product specifications associated with one or more categories as default selections. For example, for each base model and associated floor plan(s) a default building configuration is presented to the user. Alternatively, the configurator application 115 may not have any default configuration or a default configuration may be optionally presented based on user's request. Physical product categories may also be defined differently. For example, the base model and building/floor plan(s) may be defined as one category, instead of separate categories, where each selectable specification corresponds to a base model with associated floor plan(s). The user may choose to replace the default selection by another specification, or simply select a specification, among the available ones. A building configuration, also referred to in the context of this application as “recipe” or “configuration recipe”, can therefore be described as a list of pairs each includes a category and a corresponding selected specification.

As described above, selectable specifications may be presented to users per single category, e.g., “Options,” as described with regard to FIGS. 6B to 61, and may be described as such in the building configuration. Physical product specifications related to multiple categories may also be grouped such as in the case of palettes and packages. Reasons for grouping physical product specifications related to multiple categories include ensuring specifications compatibility, facilitating customization by suggesting specifications that work well or look good together, and offering competitive prices by grouping items that are on sale or that are from a single merchant. For example, with regard to specifications compatibility choosing one specification in a first category might imply the selection of a given specification in a second category and as such the two categories may be grouped in a ‘package’. In customization scenarios where a user is exploring and selecting colors and/or textures for two or more categories, the configuration platform provides preconfigured sets of specifications that match well in the form of a ‘palette’. Palettes and packages may also be preconfigured based on other criteria such as business considerations, e.g., prices and/or quality of grouped specifications, design considerations, e.g., available space(s) versus dimensions of corresponding items, and/or the like. Packages and palettes offer a way to help the user be more efficient when configuring a building.

From the user's perspective, specification selection is done by navigating a hierarchical tree of sections and subsections. At each leaf node of the tree, the user can select and/or specify specifications as a package, a palette, or per individual categories, where corresponding leaf nodes are referred to in this application as ‘package leaf’, ‘palette leaf’ and ‘options leaf’ respectively. When in a package leaf, the user is presented with a list of available preconfigured packages to select from. One package may be selected by default. Selecting a package implies selecting a specific specification for each category of the package leaf. Packages are therefore used to enable the user to select multiple specifications at once. The user may not select individual specifications from the specifications grouped in one package. As such, compatibility between items may be enforced, for example, by using packages. Once a package is selected, the individual categories it applies to may not be customized in a way where corresponding selected specifications are modified individually.

When in a palette leaf, the user is presented with a list of available preconfigured palettes to select from. One palette may be selected by default. Selecting a palette among the available ones results in selecting a specific specification for each category of the palette leaf Palettes are therefore used to help the user select multiple specifications at once. However, unlike packages, the user is enabled to select a given category in the palette leaf and change its selected specification individually, thus customizing the chosen palette, e.g., by overriding one or more of its specifications. The user for example may operate on a representation, an icon or a tab associated with a category or a corresponding specification in the palette to view alternative specifications for the same category.

Alternative specifications for a given category in the palette leaf, for example, include all the specifications of the same category listed under alternative palettes or a subset thereof.

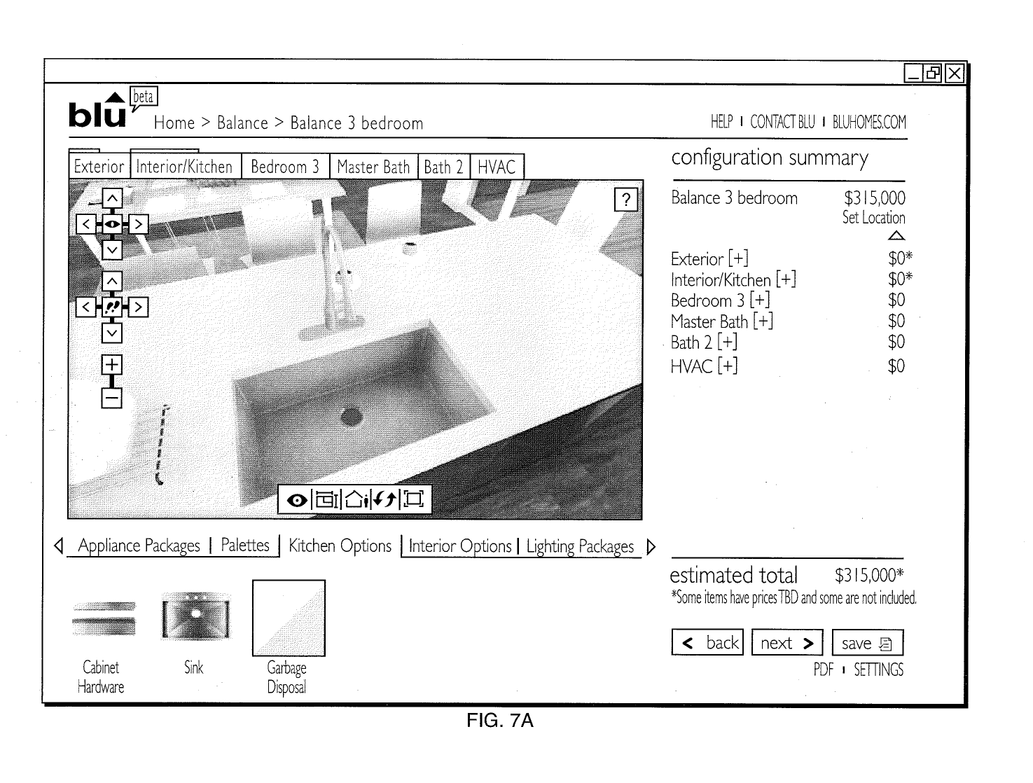

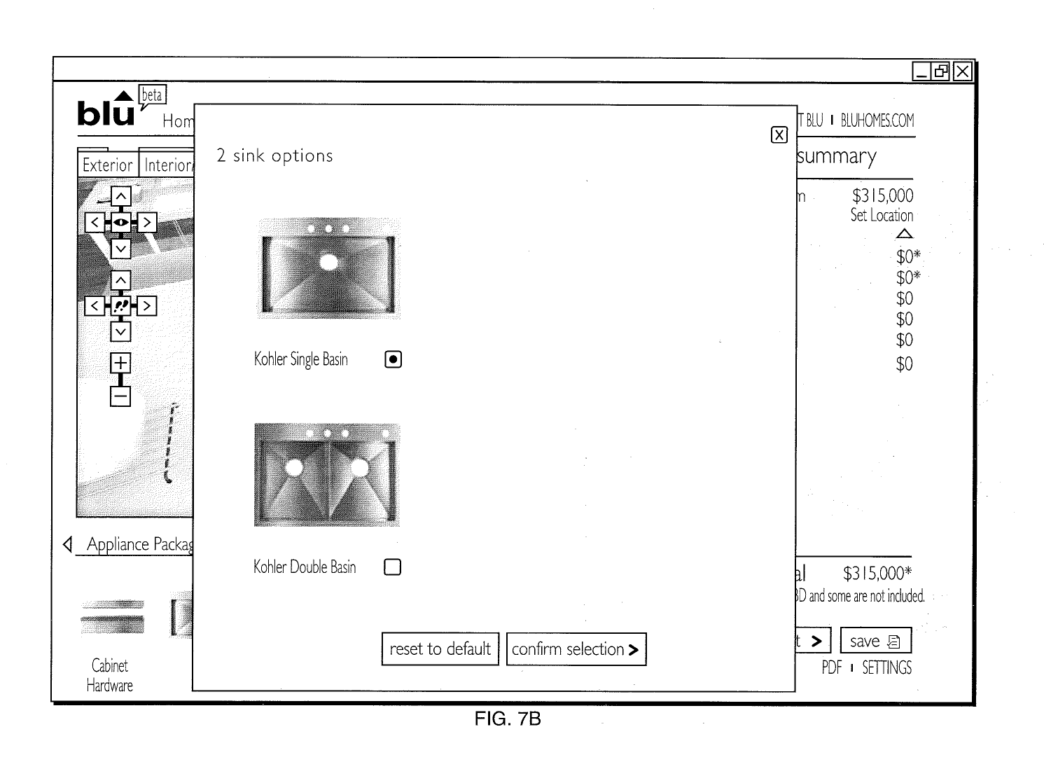

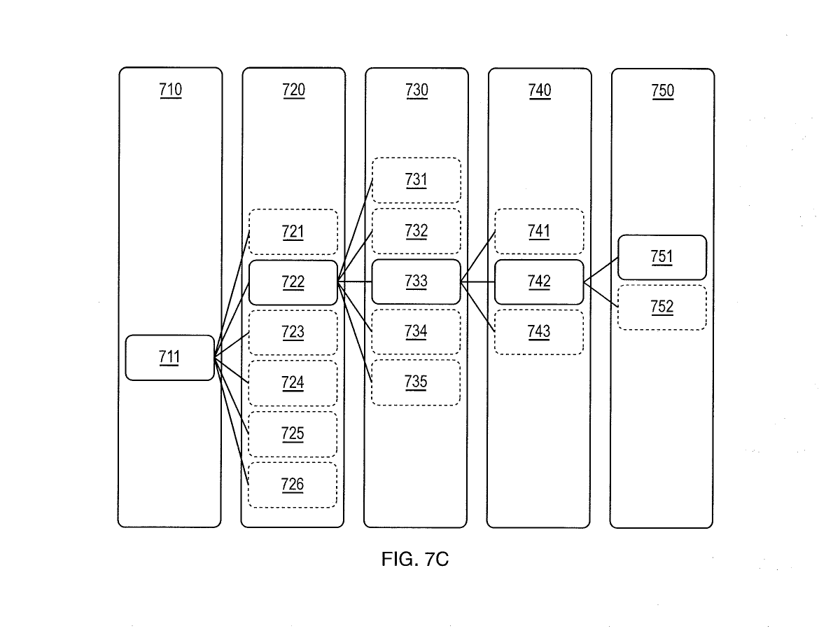

FIGS. 7A to 7C illustrate navigation of a hierarchical configuration tree. FIGS. 7A and 7B illustrate the customization of a kitchen sink, while FIG. 7C shows a part of the navigated configuration tree. The level 710 represents different nodes of base models with associated floor plan(s). For example, node 711 corresponds to the “Balance” base model 301e with three bedrooms as shown in FIG. 7A. The level 710 includes other nodes, not shown in FIG. 7C for the sake of simplicity and clarity, corresponding to other building base models with associated floor plans. As such, the configurator application 115 uses multiple hierarchical configuration trees each corresponding to a base model with associated floor plan(s) or one single hierarchical configuration tree with multiple sub-trees each of which corresponds to a base model with associated floor plan(s). The level 720 represents nodes corresponding to space areas and/or classes of physical product categories such as exterior, interior/kitchen, bedroom(s), bathroom(s), HVAC, landscape, and/or the like. For example, nodes 721 to 726 correspond to the space areas and/or classes of physical product categories “Exterior,” “Interior/Kitchen,” “Bedroom 3,” “Master Bath,” “Bath 2,” and “HVAC,” respectively, shown in FIG. 7A. The nodes 721 and 723 through 726 are shown in dashed lines indicating that these nodes are temporarily deactivated since the user according to FIG. 7A is customizing the interior/kitchen represented with node 922 shown in continuous lines indicative of active node. The level 720 further includes other nodes, not shown in FIG. 7C, representing other space areas and/or classes of physical product categories listed under other nodes than 711 corresponding to other building base models with associated floor plans.

The level 730 represents nodes corresponding to options, packages, and palettes. The nodes 731 to 735, for example, correspond respectively to “Appliance Palettes,” “Palettes,” “Kitchen Options,” “Interior Options,” and “Lighting Packages” shown in FIG. 7A. Since the user is customizing one of the categories listed under “Kitchen Options,” according to the example of FIG. 7A, the nodes 731, 732, 734, and 735 are shown in break lines while node 733 representing “Kitchen Options” is shown in continuous lines indicative of active node. The level 730 includes more nodes, not shown in FIG. 7C, children to nodes in level 720 other than 722, for example. Three physical product categories namely “Cabinet Hardware”, “Sink”, and “Garbage Disposal”, shown in FIG. 7A as listed under “Kitchen Options”, are represented in FIG. 7C with the nodes 741 to 743, respectively. Level 740 represents nodes with respective parent nodes being in level 730. According to FIG. 7B, the user is customizing the sink represented by the active node 742 shown with continuous lines. FIG. 7B shows two representations of two distinct sink specifications are presented to the user in a pop-up window. The two sink specifications are represented with the nodes 751 and 752 in FIG. 7C. The level 750 includes nodes children to other nodes in level 740. The active node 751 represents the sink specification selected by the user.

A person of ordinary skill in the art recognizes that FIG. 7C shows only part of a configuration tree illustrating the user's navigation through a hierarchy of physical products specifications associated, for example, with a building base model and corresponding floor plan(s). Configuration trees may be organized according to other ways different from the example in FIG. 7C. For example, a configuration tree may associated with a given base model and having another level, compared to FIG. 7C, between levels 710 and 720 including nodes corresponding to different floor plan(s) of the given base model. According to another example, level 720 of FIG. 7C includes three nodes, e.g., “Options”, “Packages”, and “Palettes”, where the “Options” node has nodes 733 and 734, corresponding respectively to “Kitchen Options” and “Interior Options” as well as other nodes representing single category options. The node “Packages” would have nodes 731 and 735, representing respectively “Appliance Packages” and “Lighting Packages”, as well as other nodes representing other packages available in association with a base model or a base model and corresponding floor plan(s). Similarly, the node “Palettes” would be a parent node to all available palettes in association with a base model or a base model and corresponding floor plan(s). According to even another example, a configuration tree may have levels 710, 730, 740, and 750 of FIG. 7C only and no level 720. In such case, nodes of level 730 are directly connected to nodes in level 710.

According to one aspect, the configurator application 115 activates and/or deactivates nodes of a configuration tree as the user navigates the virtual representation of the building and customizes physical product specifications. Activated nodes simply represent a last selected node by the user and respective parent nodes. The configurator application 115 may activate and/or deactivate nodes according to a different way. For example, only a last selected node by the user is activated. According to another aspect, activated nodes represent selected physical product specifications nodes and default specifications nodes not modified by the user as well as the respective parent nodes. In other words, the activated nodes represent a current instance of the building configuration and as such the activated nodes are used by the configurator application 115 to determine what items to be displayed to the user as he/she navigates the virtual representation of the building configuration. Deactivated nodes represent alternative specifications, packages, and/or palettes that are not included in a current building configuration.

According to one or more other aspects, selecting a given specification in one category may display some other specifications related to other categories unavailable for selection or presentation. Even more, packages and/or palettes may become unavailable. Example implementations of the configuration platform use conditionals, e.g., boolean expressions, to correlate available specifications choices, e.g., options, packages, and/or palettes, to already made user selections. Conditionals are introduced as a way to easily describe consequences of specification, package and/or palette selection on other specifications, palettes, and/or packages. A conditional basically defines, for a given specification, package and/or palette, whether or not it is available for presentation and/or selection based on other selections of other specifications, packages and/or palettes.

A conditional is a boolean expression whose arguments are other specifications, packages, and/or palettes. Consider example specifications S1, S2, S3 and S4. If the availability of S1 depends on S2, S3 and S4, a conditional is associated to S1 to describe such dependency. For instance, the conditional ‘S2 & !S3’ states that Si is available only if S2 is selected and S3 is not selected. Conditionals may contain the following symbols: & for AND,|for OR, ! for NOT. Other example implementations of the configuration platform may use other symbols and/or character strings to express Boolean operations. Conditionals offer a data-driven description of relationships that can be easily accessed and modified inside and/or outside of the configurator application code. For example, conditionals may be stored in a database, or simply in a document describing building configuration rules. The document may be of format such as XML, spreadsheet, or any other format. By storing the conditionals and/or the building configuration rules in a document separate from the configurator application code, incorporating modifications to such rules becomes easy and straight forward.

When the user changes the building configuration, for example by making a selection of a specification, a package and/or a palette, all the conditionals are re-evaluated. Individual specifications, palettes, and/or packages that become unavailable upon user changing the building configuration are not presented to the user as customization choices. Alternatively, such individual specifications, palettes, and/or packages may be presented to the user as non-selectable choices. Further information may also be displayed to the user explaining why such choices are non-selectable. In other example implementations of the configuration platform, individual specifications, palettes, and/or packages previously selected in the building configuration that became unavailable after, for example, a conditional changed are removed from the building configuration and replaced by the corresponding default specifications, palettes, and/or packages.

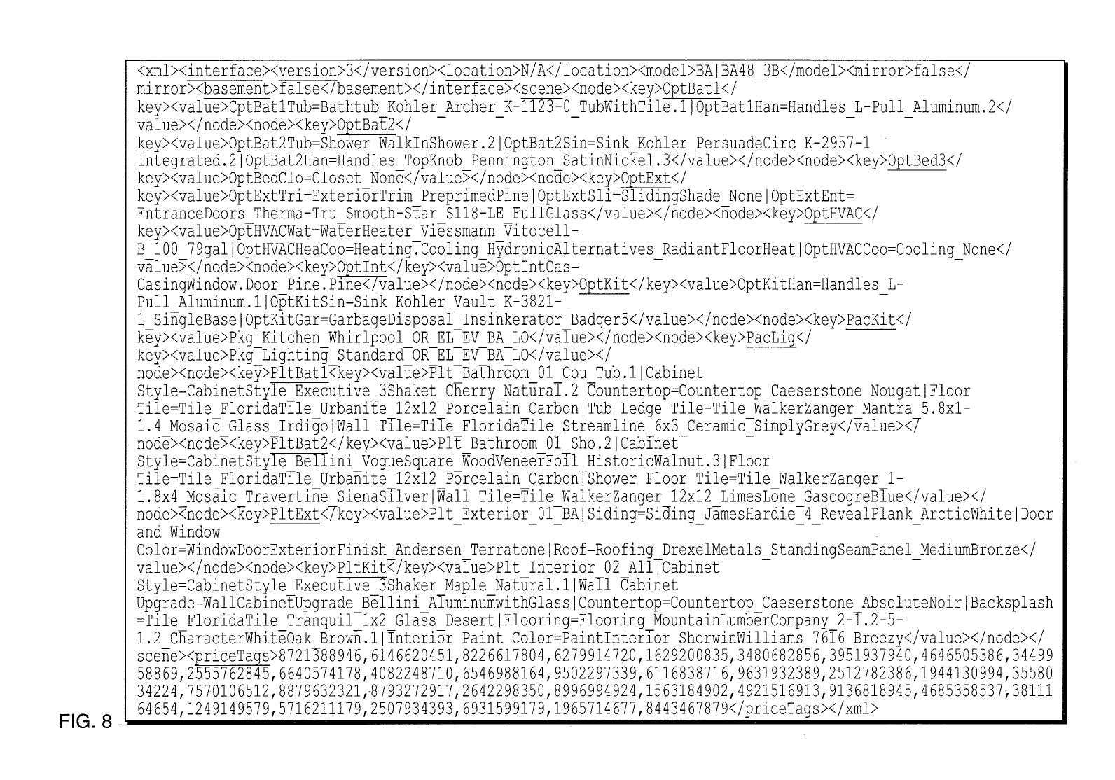

Acoording to one aspect, the configurator application 115 causes the client device 110 to save a building configuration, or a building configuration recipe, indicative of the physical product specifications included in a current and/or customized configuration. A building configuration recipe is saved as a list, a tree, a table, or in any other form. FIG. 8 shows an XML document illustrating an example building configuration recipe. In order to facilitate reading and decoding the content of the XML document in FIG. 8, some markup terms are underlined. The markup “interface” is indicative of an interface of the building and includes other markup terms such as “version” which indicates the version of configurator application 115 and/or a version of the set of physical product specifications from which the building configuration recipe is extracted. The markup “interface” also includes the markup term “location” referring to the location of the building, the markup “model” indicative of the base model and associated floor plan(s), the markup “mirror” used to indicate whether floor plan(s) is/are flipped according to a symmetric image of a respective default orientation, and the markup “basement” indicative of whether the building has a basement. The content “BA|BA48_{—}3B” associated with the markup “model” refers to a “Balance” base model with an associated floor plan having three bedrooms. The markup “scene” includes all other physical product specifications included in the building configuration. The markups “OptBat1”, “OptBat2”, “OptBed3”, “OptExt”, “OptHVAC”, “OptInt”, and “OptKit”, for example, refer to Options associated with a first bathroom, a second bathroom, a third bedroom, exterior, HVAC, interior, and kitchen respectively. Similarly, the markups “PacKit” and “PacLig” refer to packages associated with, respectively, kitchen and lighting. The markups “PltBat1”, “PltBat2”, PltExt” and “PltKit” refer to palettes associated with a first bathroom, a second bathroom, exterior, and kitchen respectively.

The content associated with the markup “PriceTags” includes a list of identifications (IDs) indicative of all the specifications associated with the building configuration. In other words, the list of IDs is a redundant description of the building configuration in the same XML file. The building configuration recipe may also be stored in the form of a URL using part or all the description provided in the XML file of FIG. 8. An example of such URL includes a web address followed by the iDs associated with “PriceTags”, e.g., . Alternatively, the URL includes the web address followed by the description in the XML file of FIG. 8 associated with the markups “interface” and “scene”, e.g.,. The building configuration recipe, whether in the form of an XML document, a URL, or any other form is used to communicate the user's customized building configuration to others.

According to one aspect, the configurator application 115 enables displaying a representation of the building configuration in 2D or 3D. A virtual 3D representation is displayed in real time and the configurator application 115 enables the user to freely walk around, inspecting each space area and/or physical product category from different viewpoint angles. Alternatively, a set of 2D images is used to describe a representation of the building configuration from predetermined viewpoints. According to one aspect, the configurator application 115 provides a 2D mode and a 3D mode. The user may be enabled to select one of the modes, for example, at the stage of downloading and/or installing the configurator application 115. The configurator application 115 may also automatically switch between the two modes based on one or more criteria such as the client device 110 capabilities and/or enable the user to switch between the modes. The configurator application 115 may automatically switch to displaying virtual 2D representation, upon detecting that the frame rate at which the virtual 3D representation is displayed is relatively slow.

While the realtime 3D representation of the building offers the user flexibility and good visualization experience, a set of 2D images, or the 2D representation, may be used at least as a backup solution for users who don't have the required hardware configuration to display the building configuration as a 3D representation. The display of the 2D images, however, is responsive to user customization of the building configuration. For example, whenever the user makes a change in the configuration, the application displays the image illustrating the change/customization made by the user. The images may be, for example, accessed from the server 120 and received at the client device 110 in response to user's interaction with the client device 110 and the configurator application 115.

A back-end 2D images creation module of the configurator platform uses the list of categories with the respective specifications, palettes, and packages, to produce 2D images describing all possible home configurations from a set of viewpoints. As the number of combination is exponential and theoretically quickly reaches millions of images, the 2D images creation module is configured to only focus on a subset of relevant images to create or produce. For instance, when displaying the kitchen, only the categories associated with the kitchen have an impact on the resulting image. In other words, changing a specification in the bathroom will have no effect on how the kitchen looks like. As such the number of images to create or produce is decimated. For each viewpoint, only the list of physical product categories in the building configuration that affect the content to be displayed with respect to the same viewpoint are taken into consideration when determining the different possible images to be created or produced.

According to one aspect, the 2D images creation module is passed a file document that contains the list of viewpoints to for which images are to be produced or created, and the list of relevant categories associated with each viewpoint. The 2D images creation module then uses a brute force approach to determine all the possible combinations of specifications, packages and/or palettes associated with the categories relevant to each viewpoint. For each combination, one image is produced or created from each respective viewpoint and encoded. Filenames of produced images may be constructed in a way to indicate respective viewpoints and relevant specifications, packages, and/or palettes. Alternatively, a table, a tree, another data structure, and/or a file document is used to match each produced image to a respective viewpoint and relevant specifications, packages and/or palettes. The images are then retrieved by the configurator application when running in 2D mode by, for example, reconstructing the appropriate filename using the current viewpoint and the relevant categories and the respective selected specifications, packages, and/or palettes. The images may be produces in real time by the server based on information received related to user interaction with the client device.

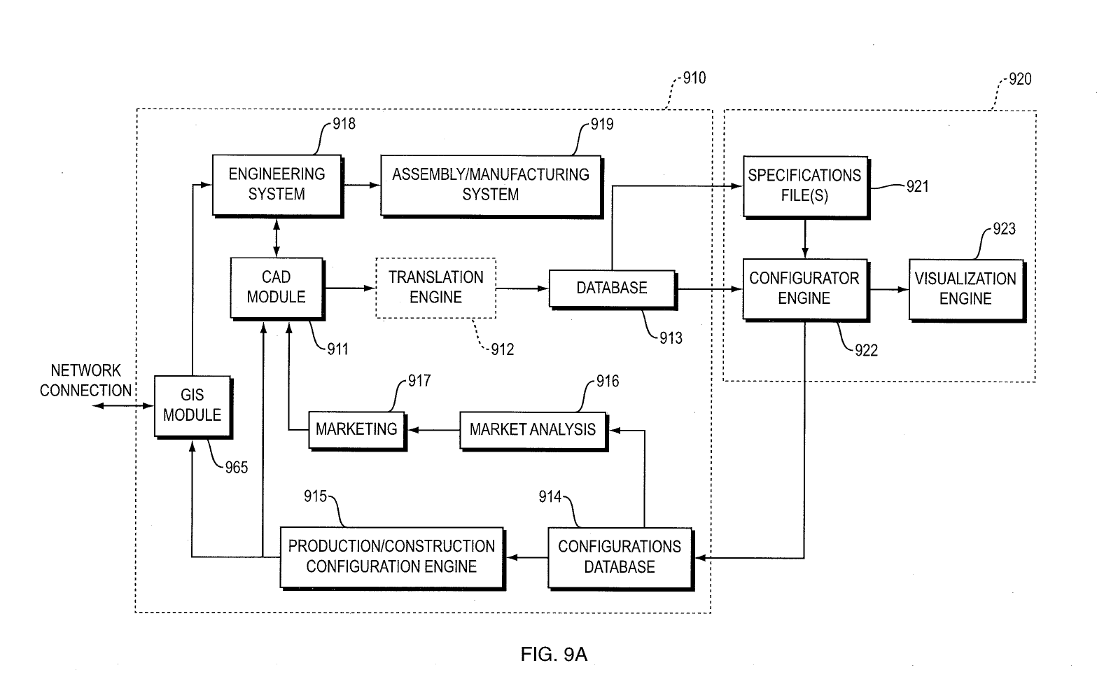

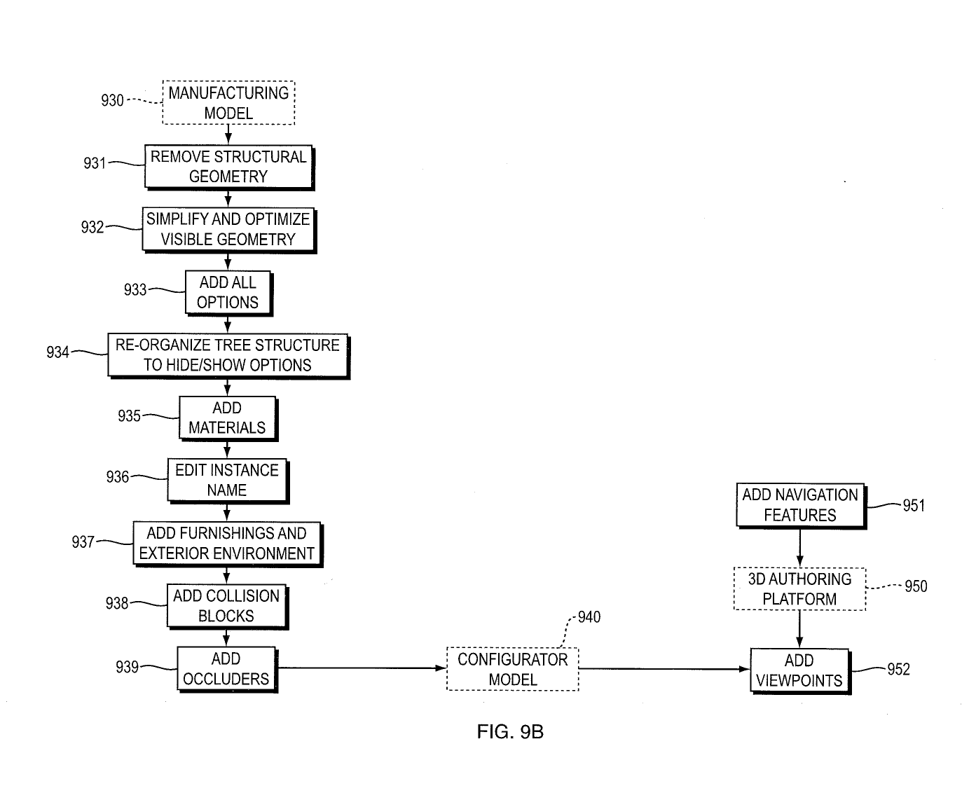

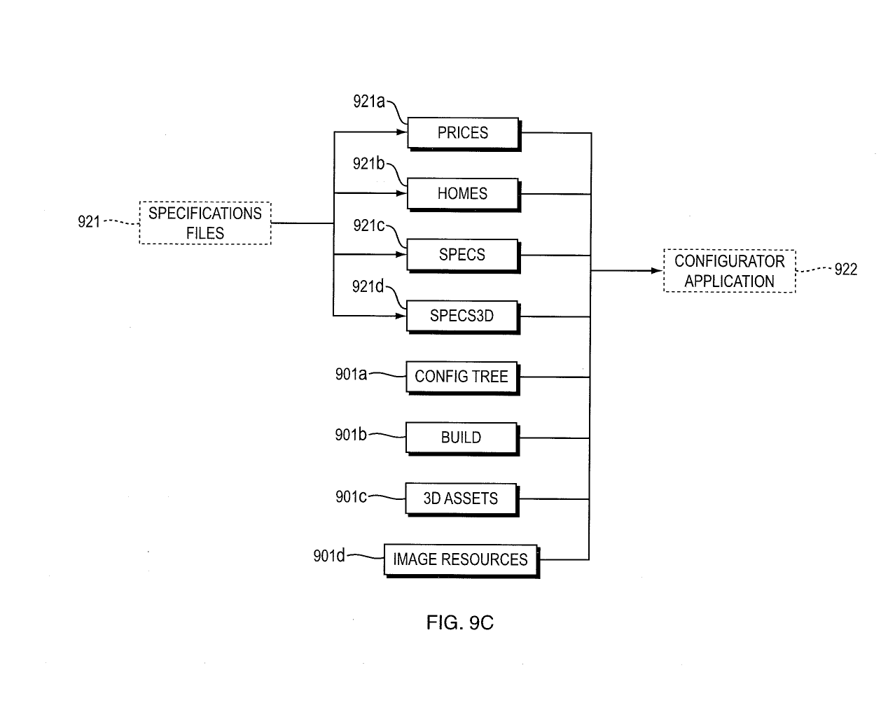

FIG. 9A shows an block diagram of a configuration platform according to an example embodiment of the present invention. The configuration platform includes a back-end system 910 and a front-end or client application 920. The front-end application 920 includes software modules, data structures, and/or electronic files executed, stored, and/or accessible by the client device 110. The back-end system 910 comprises one or more computer servers, one or more databases, and software modules, data structures and electronic files operating thereon.

Specifically, the back-end system includes a computer-aided design (CAD) module 911 operating on one more computer servers. The CAD module 911 is a design software tool used to assist in the creation, modification, analysis, or optimization of a building design. For example, technical drawings describing the building design are usually drafted using the CAD module 911. An example of a CAD module 911 is the CATIA software usually used in the aerospace industry. According to an example embodiment, the CATIA software is used to construct a 3D engineering model of the building. The 3D engineering model includes a 3D virtual representation of the building together with engineering information such as structural geometry information, information related to plumbing, information related to electric installation, or the like.

The 3D engineering model generated using the CAD module 911 is computationally very complex and does not provide enough user interaction to enable virtual walk navigation, for example. FIG. 9B shows a flow chart of a process for simplifying the 3D engineering model 930 into a configurator model 940. At block 931, non-visible geometry such as structural geometry and/or other geometrical information related to, for example, wall studs, electric installation, plumbing, and or the like is removed from the 3D engineering model 930. At block 932, the geometry, e.g., 3D mesh, of the 3D engineering model is simplified by reducing the corresponding geometrical resolution. Reducing the geometrical resolution may be achieved by reducing the number of polygons used or using any other technique known in the art. The simplification of the geometry results in significant reduction in computational complexity. At block 933, all possible configurations based on different combinations of physical product specifications are added to the model. At 934, configuration tree(s) is/are constructed and/or re-organized in a way to reflect different possible configurations. At 935, texture and/or colors corresponding to different materials are added to the model. At 936, different names are attributed to distinct configurations and/or different items/objects in the configurations. The attributed names are used to refer to different physical product specifications in a specifications file, for example. At 937, objects associated with the exterior environment and/or furniture are added to the model. Finally, collision block and occluders are added at 938 and 939, respectively, to obtain the configurator 3D model 940.

The configurator 3D model 940 is passed to a translation engine 912 where the file format of configurator 3D model may be changed if needed. For the 2D mode of the configurator application 115, different images corresponding to distinct viewpoints and different combinations of specifications of physical products are produced and and made accessible to a user or a corresponding client device. For the 3D mode, however, the translation engine includes a 3D authoring platform, e.g., Unity3D, that is used to add navigation features 951 and embed pre-configured viewpoints 952 in the configurator model 940. The configurator model 940 is then stored in the database 913 together with software modules of the configurator application 115. For 2D, images may be produced in real time. The database 913 is configured to store and provide access to configurator application 115 software module(s), data structures and/or other related files for client devices 110. For example, the database 913 includes or is coupled to one or more server 120. Stored files include, for example, documents including specifications of physical products, documents of configurations tree(s), or the like.

According to an example embodiment, a process for simplifying an engineering model of a building into an interactive 3D building configuration includes simplifying geometrical data of an engineering model of a building to produce a simplified three-dimensional (3D) representation of the building. The simplification of geometrical data may be achieved, for example, according to blocks 931 and 932 of FIG. 9B. The process also includes associating the simplified three-dimensional (3D) representation of the building and a subset of a set of 3D representations or assets of physical product specifications to a 3D building configuration. A 3D building configuration may be defined using the simplified 3D representation of the building and the associated subset 3D representations or assets of physical product specifications. Associating the subset 3D representations of physical product specifications may be achieved, for example according to blocks 933, 935, and 937 of FIG. 9B. Then, adding navigation features, within a 3D authoring platform, to the 3D simplified representation of the building enables 3D navigation of the 3D building configuration as described in block 951 of FIG. 9B. Other operations described with respect to other blocks of FIG. 9B may be optional in an engineering model of a building into an interactive 3D building configuration, depending on different implementations of the simplification process.

Two or more subsets of 3D representations of physical product specifications may be associated to respective two or more 3D building configurations. At least one data structure, e.g., tree, table, lists, or the like, may be arranged to describe which subset of 3D representations of physical product specifications is associated a given 3D building configuration. The data structure also illustrates how the 3D representations of physical product specifications in the subset associated with the given 3D building configuration would be organized for proper display of the given 3D building configuration. For example, if the data structure is a tree as described with respect to FIG. 7C, the tree describes in which space area a 3D representation of a physical product specification is to be shown or displayed.

According to an example embodiment, a user causes the client device 110 to download the configurator application software module(s) and specifications file(s) 921 and install the configurator application 115. After installation, a configurator engine 922 and a visualization engine 923, operable in the client device 110, cause the display of a virtual representation of the building configuration to the user and enable navigation and customization. The configurator engine 922 uses downloaded specifications documents and information therein to determine instances of the virtual representation of the building to be displayed. Information about determined instances is passed to the visualization engine 923 which, in response, causes the client device to display the determined instances. The configurator engine 922 is configured to keep track of the user's selected specifications and save building configurations recipe(s). The configurator engine 922 may be viewed as the core of the configurator application 115.

According to an example embodiment, the visualization engine 923 includes one or more applications related to displaying content associated with the virtual representation of the building configuration. For example, the visualization engine 923 may be implemented as a combination of Flash and Unity3D. When configurator application 115 is running in 2D mode, a Flash window is used to display the configuration tree and the available specifications of physical products in the currently selected tree leaf as well as 2D images associated with viewpoints of the virtual representation of the current building configuration. When running in 3D-mode, the 2D images associated with viewpoints of the virtual representation of the current building configuration are replaced with a real-time 3D representation of the building configuration. The visualization engine 923 causes the client device 110 to overlay a Unity3D window on top of the flash application as shown in FIGS. 5D and 6C, for example, where the visualization widow 510, 610, is a Unity3D window and the rest of the displayed content is part of the Flash window. The Unity3D window is placed on top of the flash window using web browsers, for example, layering features such as HTML ‘div’ tags. The Unity3D window may be shown or hidden at any given time by accessing a web page HTML Document Object Model in javascript.

Communication between Flash and Unity3D is done using javascript. Unity3D is driven by Flash. Flash keeps track of the configuration and sends it to Unity3D whenever it changes, and Flash also controls automated viewpoint changes when the user switches between tree sections. For some features, Flash requires a snapshot of the 3D real time scene, for instance, for printing purposes. When needed, Flash requests the snapshot from Unity3D through javascript. Unity3D then compresses the current displayed view as a base64-encoded JPEG image. The image data is passed to Flash through javascript in chunks, and reconstructed at the other end of the pipe in Flash. To prevent the javascript pipe between unity and flash to overflow, the data may be split in chunks, e.g., 16KB chunks of data. The recombined data is then decoded and displayed in Flash, replacing the real-time 3D content. Once the image is ready and displayed in Flash, the Unity3D layer may be hidden without the user noticing any difference. The 3D scene may seem to have ‘frozen’, when in fact the Unity3D layer has been removed from the screen. This technique enables the overlaying of Flash 2D widgets on top of the 3D view by faking the overlay, freezing the 3D view, hiding it and displaying its snapshot using Flash.

FIG. 9C illustrates an example of different documents used by the configurator engine 922. Specifications files 921 include, for example, a specifications' document 921a with price information. The price information associated with different specifications of physical products is used by the configurator engine to 922 calculate and cause the display of a cost estimate of a building configuration and difference amounts in the estimated cost as the user customizes the building configuration. The specifications' document 921b includes information related to different base models and corresponding floor plans. The document 921c includes the list of available specifications of physical products, while the 3D specifications document 921d includes 3D information related to 3D objects representing physical products such as color/texture information, size information, and/or the like. According to another example, the information included in the specifications documents 921a to 921d may be grouped in one specifications document or even distributed differently among a number of documents. Also, the format of the documents 921a to 921d may be XML, spreadsheet, or any other format.

The document 901a includes one or more configuration trees illustrating the different possible building configuration instances. The document 901b includes a tree associated with a current configuration of the building and is used by the visualization engine 923 to determine the content to be displayed. The document 901b changes as the user modifies his/her selections. The conditionals, describing correlations between different possible user selections, may be provided in a separate document or described within the configuration tree(s) in the document 901a. The blocks 901c and 901d represent folders and/or databases of 3D assets and 2D images, respectively, representing components of displayable content. Both 901c and 901d may be directly accessible by the visualization engine 923 rather than the configuration engine 922.

The configurator engine 922 is configured to save a building configuration recipe and cause it to be sent to a configurations database 914 of the back-end system 910. For example, after the user finalizes the configuration of the building, e.g., his/her home, the configuration is stored in the form of a file document, a URL, or any other format and sent to the back-end database 914. The database 914 may be a separate database, the same database as 913 or a database associated with a computer server of the back-end system 910. The building configuration is then passed to a production/construction configuration engine 915. The production/construction configuration engine 915 facilitates automating the process of translating a customer defined configuration into a fully designed engineering model of building. A fully designed engineering model is a model having standard engineering specifications used in the construction process. For example, the user-defined configuration is mapped to, or used to generate, an engineering model of building including structural geometry, architectural drawings, design and construction information related to plumbing, electric installation, a bill of materials, and/or the like. The production/construction configuration engine 915 may apply company-defined rules, parameters, best practices, regulation rules, and/or the like when translating the customer defined configuration into the fully designed engineering model of building.

According to an example embodiment of FIG. 9A, the production/construction engine 915 is coupled to the CAD module 911 and an engineering system 918. The production/construction engine 915 interacts with the CAD module 911 in the process of translating a user-defined building configuration into a fully designed engineering model. For example, the production/construction engine 915 translates the user-defined building configuration into an engineering building configuration. The engineering building configuration may be in the form of an XML document, a spreadsheet document, a tree structure, a list, and/or the like and usually includes engineering information besides the information in the user-defined configuration. The engineering building configuration is then passed to the CAD module 911 where it is mapped to a fully designed engineering model. The engineering system 918 provides an interface for engineers and/or architects to generate, modify, or inspect engineering models used in the construction of buildings. A building engineering model is the collection of information and/or engineering instructions in the form of documents, drawings, computer code instructions, data structures that are used in the construction, remodeling, and/or decoration process. According to an example embodiment, the production/construction configuration engine 915 may be a component of the engineering system 918.

The engineering system 918 is also configured to generate or provide, automatically or semi-automatically, downstream documentation, list of deliverables, project management information, or the like. The information generated or provided may be in the form of schematic drawings for regulatory agencies, drawings for factory agencies, computer instructions for automated production, or the like. The engineering system 918, according to one aspect, is coupled a Geographic Information System (GIS) module 965. The GIS module 965 is a configured to collect, retrieve, store, manipulate, analyze, manage, and provide access to different types of geographical information data. The GIS module 965 is coupled through a global communications network, e.g., the Internet, to one or more local or federal government databases, environmental institution(s) database(s), organization(s) database(s), or the like. The GIS module 965 is configured to collect regulatory information data, geologic information data, snow loads data, wind loads data, or any other information related to a location of the building from external databases. The GIS module 965 may also collect such data from a database of the back-end system 910 storing project information data of one or more construction, remodeling, or renovation projects associated with one or more other buildings in proximity with the location of the building corresponding to the building configuration. The collected geographic information data is used, for example, in the engineering system 918 to update, filter, add, or remove specifications of physical products available to users for selection when configuring a building. The collected geographic information data is also used in estimating cost associated with the building or constructions process. The collected geographic information data is also used is estimating a time duration of the construction process.

The engineering system 918 may also be couple directly or through the GIS module to the production/construction engine 915. The engineering system 918 is also coupled to an assembly/manufacturing system 919. For example, once the engineering model is finalized, approved, or inspected by engineers, the engineering model is then sent to the assembly/manufacturing system 919 where parts or components of the building are automatically or semi-automatically manufactured.

According to an example embodiment, a process performed by the production/construction configuration engine 915 includes parsing a plurality of tags indicative of physical product specifications associated with a configuration of a building, and mapping the configuration and the physical product specifications to an engineering model of the building. The plurality of tags may be included, for example, in an XML document, spreadsheet document, URL, or the like. The tags may be names or text strings associated with the physical product specifications. Alternatively, the tags may be IDs, e.g. number IDs, associated with the physical product specifications as shown FIG. 8.

The user-defined building configurations received from users are also accessed by a market analysis module 916 configured to analyze users' selections, behaviors, and preferences based on different criteria such as users' locations, ages, gender, and/or any other user information. The market analysis module 916 extracts marketing trends indicative, for example, of popular or attractive physical products, brands, styles, colors, and/or the like among users. The extracted information is used by a marketing interface to update the list of available physical product specifications, services provided by a company, prices, list of contractors, and/or any other information to improve customer satisfaction and sales. Information related to changes made to the list of available specifications of physical products, for example, is passed to the CAD module 911 where respective documents are modified accordingly.

According to an example embodiment of the present invention, the configurator platform is configured to collect geographic data from data bases of third-party entities such as regulatory agencies, local governments, environmental agencies, weather agencies or institutions, and/or the like. A geographic information system (GIS) module 965 is provided, for example, bay the back-end system 910. Geographic information, herein, is information associated with a given location and relevant to a building construction process at the particular location. The geographic information for a particular location includes geologic information, seismic information, weather related information such as snow loads, wind loads, and/or the like, regulatory information, topographic information, information related to soil type and moisture content, and/or other relevant information associated with the particular information.

The geographic information is collected and stored in database 913, database 914, or a dedicated database associated with the GIS module 965. The geographic information may also be collected also from a back-end database storing information related to previous or on-going projects. For example, a back-end building projects database stores information related to building projects performed or in progress by one or more companies. When a new building project is started, the GIS module 965 in the back-end system 910 searches the building projects database for a project with location within a certain radius of the location of the new project. Some of the geographic information for the new project may be retrieved from files associated with another close-by project. The GIS module 965 may request the geographic information from third party databases. The GIS module 965 may map collected information to respective locations and store it in a GIS database permanently. As such, the GIS module 965 may synchronize the stored data, especially the time varying data, to keep it up to date. Alternatively, the GIS module 965 retrieves geographic data when desired. For example, if a location is specified for a construction project, the GIS module 965 determines filters associated with the location, e.g., environmental, geologic, seismic, and/or regulatory filters, and retrieves geographic information according to the determined filters from the back-end building projects database and/or other third party databases. The GIS collected information may or may not be accessible to customer users.

The GIS collected data may be used in different ways including modifying the list of available base models or even modifying the design of existing base models associated with, for example, a metropolitan area, a state, a country, and/or a county. For example, in areas with usually high snow loads some base models may not be suitable, or even allowed by local regulations. The GIS collected information also affects the price of base models and/or other physical products. Wind loads, soil type and moisture content therein may affect the design of the building structure and result in changes in the cost/price. Also the topography of a location may increase the cost of transportation and delivery of physical products. The GIS collected information is also used in determining, filtering, and/or modifying available options, packages, and/or palettes as well as corresponding default selections. The GIS collected information may also affect available choices of downloadable scenery representation used in simulating the background environment of the building configuration, choices of furniture styles, and/or other specifications of physical products. The GIS collected information is also used in estimating energy consumption of a building built or to be built in a given location.

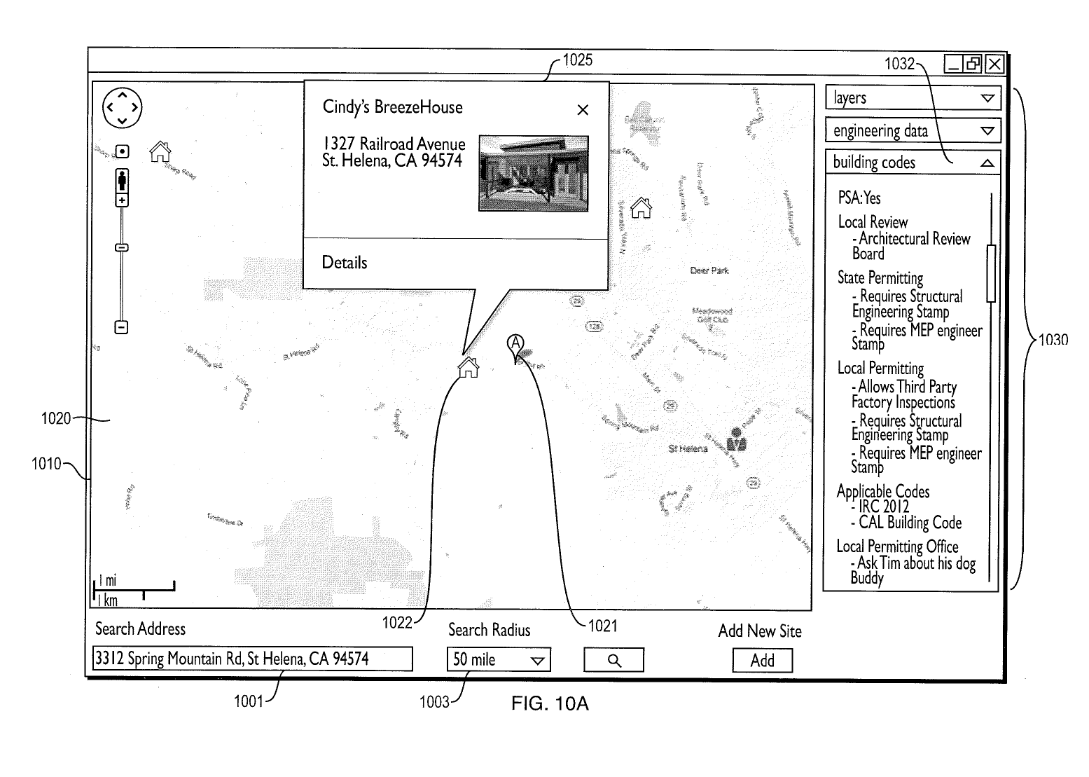

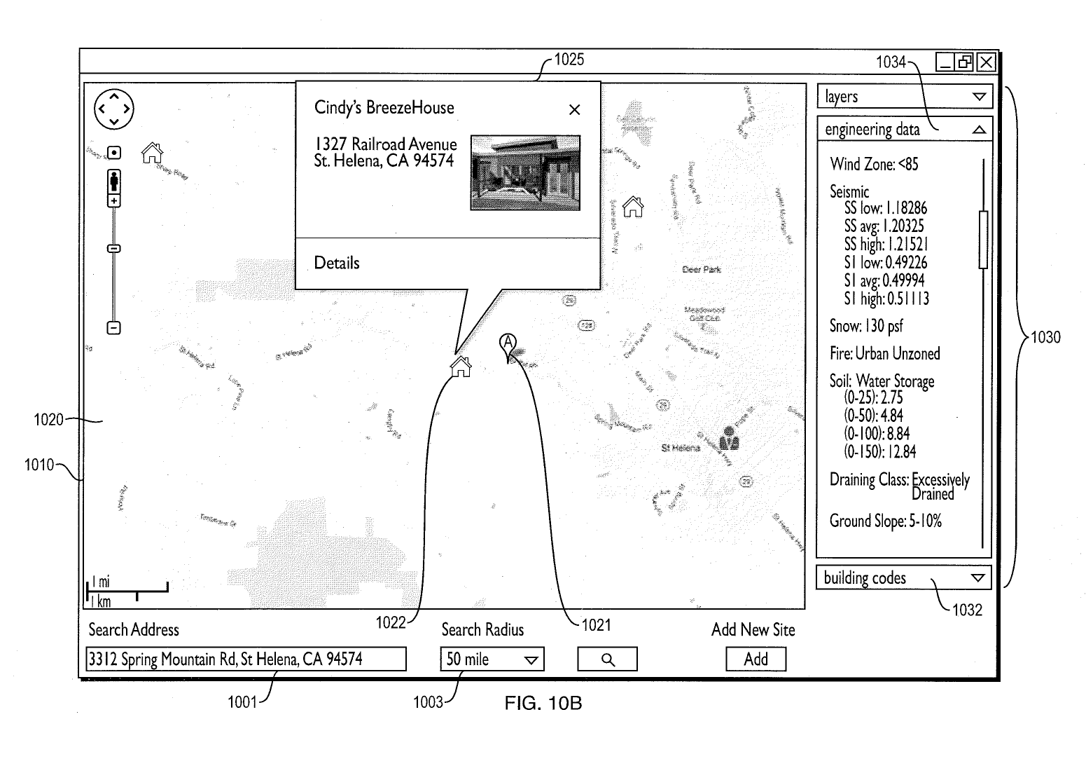

FIGS. 10A and 10B illustrate an example user interface enabling access to GIS data. The user specifies an address in an address bar 1001. In response, a map 1020 is displayed in a visualization window 1010, showing the location 1021 corresponding to the specified address on the map 1020. The location 1022 of a previous or in progress project, e.g., from the building project database, that is within a given specified radius 1003 from the specified location is also shown on the map 1020. A pop-up window 1025 enables the user to access more detailed information related to the previous or in progress project that be relevant to the specified address. A menu of tabs 1030 is also displayed to the user for providing geographic information related to the specified location/address. For example, regulatory information is listed under the tab “building codes” 1032, whereas under the tab “engineering data” 1034 information such as wind loads, snow loads, seismic information, soil moisture content, ground slope is listed. The GIS user interface may be part of the configurator application 115. Alternatively the GIS interface may be provided by another application.

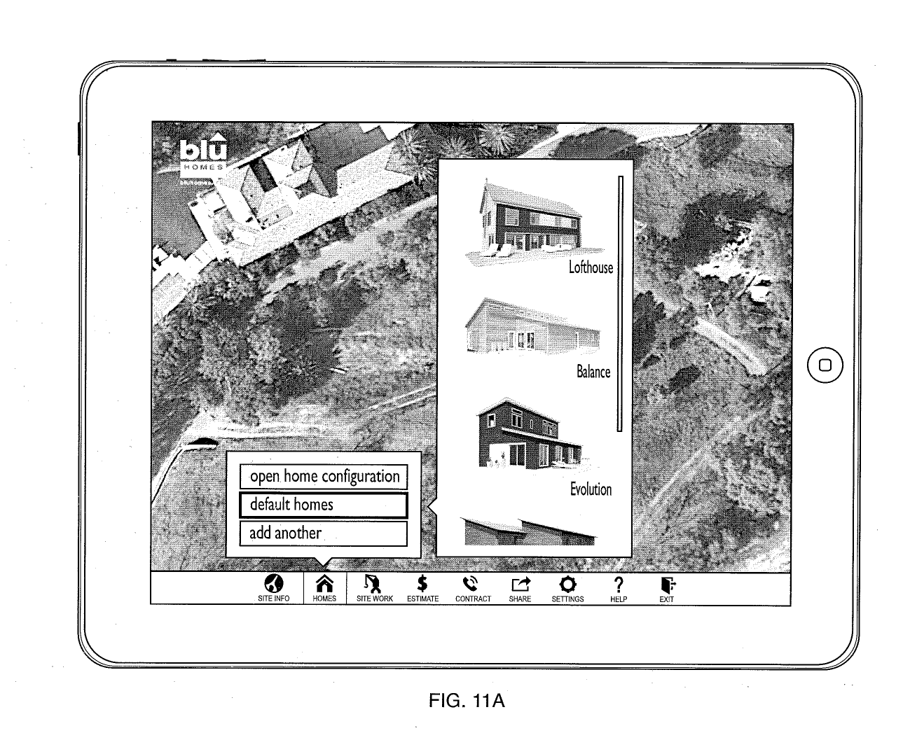

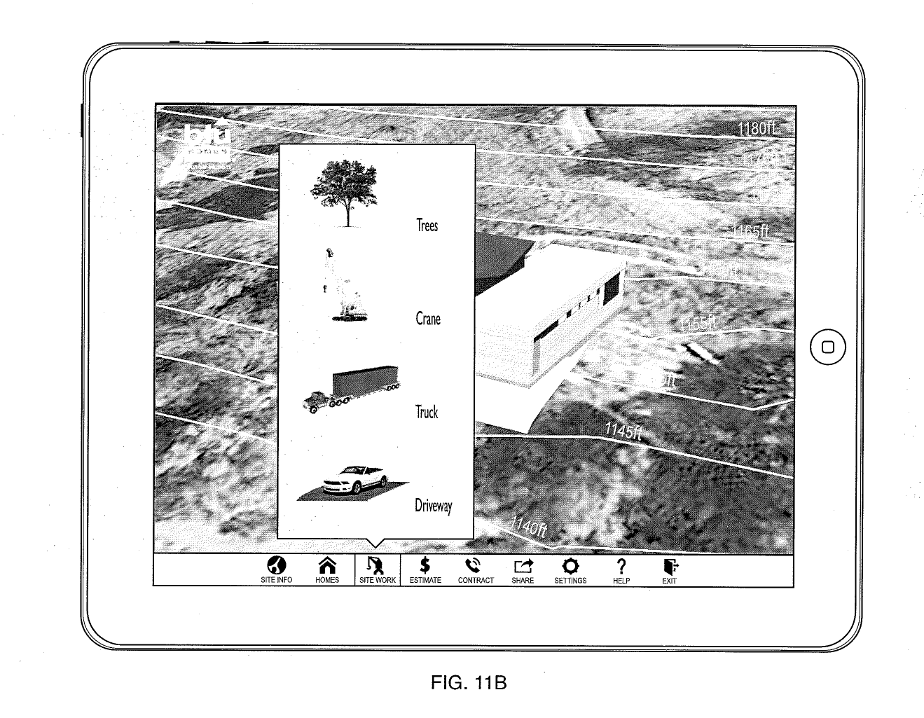

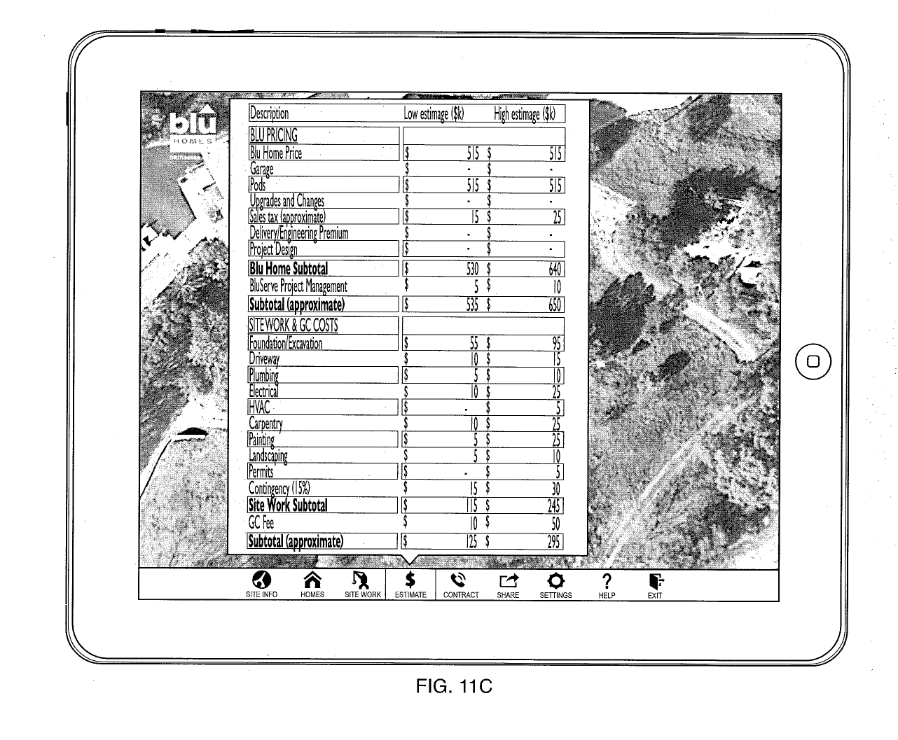

FIG. 11A shows an example user interface of the configurator application 115 to enable mapping of a virtual representation of the building configuration onto a representation of the topography of a specified location. Such feature enables the user to visualize and have a close to reality perspective on how the building and its surrounding environment would look like if built at the specified location. Representation of the location's topography may be imported/downloaded from existing services such Google Earth, Bing maps, or any other similar application.

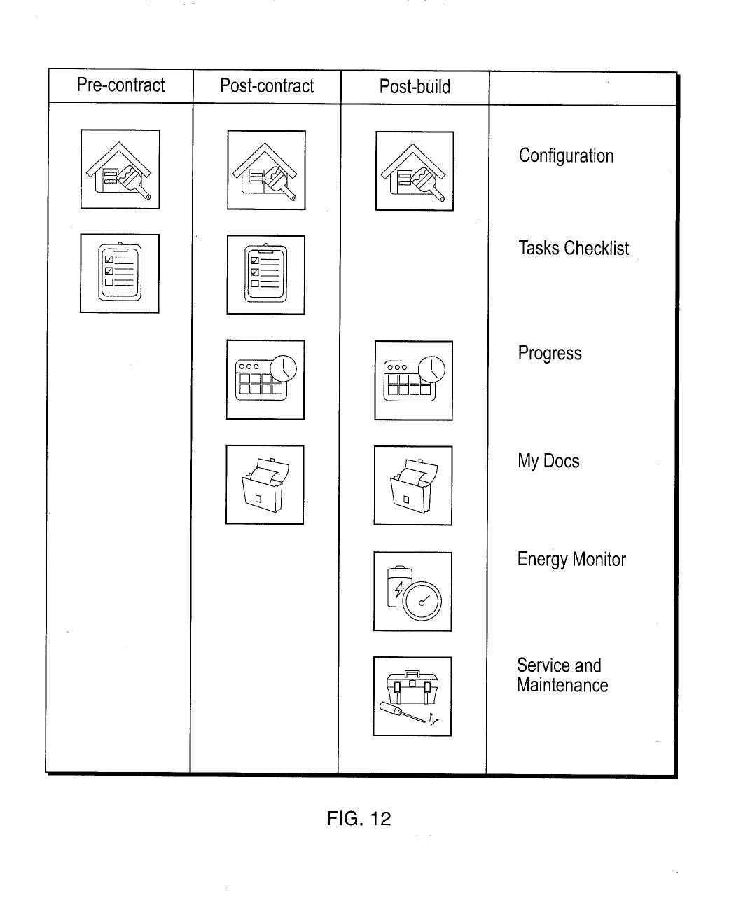

FIGS. 11B and 11C illustrate an example embodiment of enabling planning of site work and estimating respective cost. For example, using the user interface described in FIG. 11A. Based on the topography of the specified location, a user may plan and/or design driveways, locations for installing or fixing heavy machinery, site excavation, and/or any other site related work using the tools provided by a “site work” module of the configurator application 115. The module also presents to the user cost estimates associated with work to prepare the site. FIG. 12 illustrates services provided to a home buyer customer through the configurator application 115 at different stages. Prior to buying a building or a service, a customer user is enabled to configure and/or customize the building configuration. The configurator application 115 also provides to the customer user and keeps track of a list of tasks to be performed such permission documents to be executed. Upon signing a contract with a construction company other services become available to the customer user such as providing access to information related to progress in the design and construction process as well as an archive database for storing and proving access to copies of documents related to the construction project. Once the construction process is complete, even more services become accessible to the customer user. Such services include an energy monitoring module for monitoring energy consumption of the building and links to maintenance providers. Other services also include using stored building configuration recipe for marketing purposes in case the customer user decides to sell the building. It should appreciated by a person skilled in the art, that even after the building is completed, the configurator application 115 may still be used to update the building configuration, for example, as part of a remodeling or renovation process of the building.

Different modules and functionalities are disclosed with regard to the configurator platform as a system and specifically with regard to the configurator application 115. These modules may all be included in the configurator application 115. Alternatively, different applets of the configurator application 115, each supporting a subset of the modules and/or functionalities described, may be provided. For example an applet designed for a customer user may not provide GIS access while an applet to be used by an architect or an engineer provides access to GIS. In addition, different versions of an applet for customer users may be provided. An example applet may be designed to operate on a remote server while another is configured to operate on a client device.

It should be appreciated by readers of this application that the described embodiments for enabling visualization, navigation, and/or customization of the building configuration are for illustrative purposes and are not to be interpreted in a way to limit the scope of embodiments of the present invention. A person of ordinary skill in the art recognizes that while different embodiments were described, other embodiments may be implemented by modifying one or more features in a described example embodiment, combining different features from distinct example embodiments, and/or adding other features that are known in the art to one of the described example embodiments.

It is to be noted that the names “package”, “palette” and/or “options” are used for illustration only and different names may be used. Also selectable customization choices, whether packages, palettes, or individual physical product categories, may be displayed and/or organized in different ways such as in the form of a tree, a table, or even in the form of a band around the visualization window 610. A person of ordinary skill in the art appreciates that the different example embodiments described in this application are meant to illustrate different implementation scenarios and are not meant to limit the scope of the claimed subject matter. In the context of this application, client devices include personal computers, laptops, smart phones, mobile devices, tablets, and/or the like.

It should be understood that the example embodiments described above may be implemented in many different ways. In some instances, the various methods and machines described herein may each be implemented by a physical, virtual or hybrid general purpose computer having a central processor, memory, disk or other mass storage, communication interface(s), input/output (I/O) device(s), and other peripherals. The general purpose computer is transformed into the machines that execute the methods described above, for example, by loading software instructions into a data processor, and then causing execution of the instructions to carry out the functions described.

As is known in the art, such a computer may contain a system bus, where a bus is a set of hardware lines used for data transfer among the components of a computer or processing system. The bus or busses are essentially shared conduit(s) that connect different elements of the computer system (e.g., processor, disk storage, memory, input/output ports, network ports, etc.) that enables the transfer of information between the elements. One or more central processor units are attached to the system bus and provide for the execution of computer instructions. Also attached to system bus are typically I/O device interfaces for connecting various input and output devices (e.g., keyboard, mouse, displays, printers, speakers, etc.) to the computer. Network interface(s) allow the computer to connect to various other devices attached to a network. Memory provides volatile storage for computer software instructions and data used to implement an embodiment. Disk or other mass storage provides non-volatile storage for computer software instructions and data used to implement, for example, the various procedures described herein.

Embodiments may therefore typically be implemented in hardware, firmware, software, or any combination thereof.

In certain embodiments, the procedures, devices, and processes described herein constitute a computer program product, including a computer readable medium (e.g., a removable storage medium such as one or more DVD-ROM's, CD-ROM's, diskettes, tapes, etc.) that provides at least a portion of the software instructions for the system. Such a computer program product can be installed by any suitable software installation procedure, as is well known in the art. In another embodiment, at least a portion of the software instructions may also be downloaded over a cable, communication and/or wireless connection.

Embodiments may also be implemented as instructions stored on a non-transitory machine-readable medium, which may be read and executed by one or more procedures. A non-transient machine-readable medium may include any mechanism for storing or transmitting information in a form readable by a machine (e.g., a computing device). For example, a non-transient machine-readable medium may include read only memory (ROM); random access memory (RAM); magnetic disk storage media; optical storage media; flash memory devices; and others.

Further, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It also should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and thus the data processors described herein are intended for purposes of illustration only and not as a limitation of the embodiments.

While this invention has been particularly shown and described with references to example embodiments thereof, it will be understood by those skilled in the art that various changes in form and details may be made therein without departing from the scope of the invention encompassed by the appended claims.

1. A method of enabling a viewer to configure a building, the method comprising:
providing access to a plurality of specifications of physical products associated with the building;
presenting to the viewer a virtual three dimensional (3D) representation of a configuration of the building, the virtual 3D
representation structured based on specifications of physical products, within multiple categories, and relationships among the physical products in the configuration of the building;
enabling the viewer to select specifications of the physical products; modifying the configuration of the building based on the selected specifications of the physical products; and
enabling the viewer to navigate inside the virtual 3D representation of the configuration of the building according to a viewer controlled navigation.

2-81. (canceled)
